(19) United States
(12) Patent Application Publication
(10) Pub. No.: US 2025/0089124 A1
(43) Pub. Date: Mar. 13, 2025

(54) ENERGY SAVING IN WIRELESS COMMUNICATION SYSTEMS

(71) Applicant: Samsung Electronics Co., Ltd., Suwon-si (KR)

(72) Inventors: Anil Agiwal, Allen, TX (US); Sangkyu Baek, Suwon-si (KR)

(21) Appl. No.: 18/801,430

(22) Filed: Aug. 12, 2024

Related U.S. Application Data
(60) Provisional application No. 63/537,688, filed on Sep. 11, 2023.

(51) Int. Cl. H04W 76/28; H04L 5/00; H04W 72/21; H04W 72/231; H04W 72/40; H04W 74/0833

(52) U.S. Cl. CPC H04W 76/28; H04L 5/0053; H04W 72/21; H04W 72/231; H04W 72/40; H04W 74/0833

(57) ABSTRACT

A user equipment (UE) includes a transceiver configured to receive a radio resource control (RRC) reconfiguration message including a configuration of a periodic cell discontinuous transmission (DTX) pattern for at least one serving cell. The UE also includes a processor operably coupled to the transceiver. The processor is configured to determine whether a special cell (SpCell) is configured with the periodic cell DTX pattern, determine whether a random access response (RAR) window is running, and based on a determination that the SpCell is configured with the periodic cell DTX pattern and the RAR window is running, monitor a physical downlink control channel (PDCCH) of the SpCell.

### CROSS-REFERENCE TO RELATED APPLICATION(S) AND CLAIM OF PRIORITY

This application claims priority under 35 U.S.C. § 119(e) to U.S. Provisional Patent Application No. 63/537,688 filed on Sep. 11, 2023. The above-identified provisional patent application is hereby incorporated by reference in its entirety.

### TECHNICAL FIELD

This disclosure relates generally to wireless networks. More specifically, this disclosure relates to energy saving in wireless communication systems.

### BACKGROUND

The demand of wireless data traffic is rapidly increasing due to the growing popularity among consumers and businesses of smart phones and other mobile data devices, such as tablets, “note pad” computers, net books, eBook readers, and machine type of devices. In order to meet the high growth in mobile data traffic and support new applications and deployments, improvements in radio interface efficiency and coverage is of paramount importance.

To meet the demand for wireless data traffic having increased since deployment of 4G communication systems, and to enable various vertical applications, 5G communication systems have been developed and are currently being deployed. The enablers for the 5G/NR mobile communications include massive antenna technologies, from legacy cellular frequency bands up to high frequencies, to provide beamforming gain and support increased capacity, new waveform (e.g., a new radio access technology (RAT)) to flexibly accommodate various services/applications with different requirements, new multiple access schemes to support massive connections, and so on.

### SUMMARY

This disclosure provides apparatuses and methods for energy saving in wireless communication systems.

In one embodiment, a user equipment (UE) is provided. The UE includes a transceiver configured to receive a radio resource control (RRC) reconfiguration message including a configuration of a periodic cell discontinuous transmission (DTX) pattern for at least one serving cell. The UE also includes a processor operably coupled to the transceiver. The processor is configured to determine whether a special cell (SpCell) is configured with the periodic cell DTX pattern, determine whether a random access response (RAR) window is running, and based on a determination that the SpCell is configured with the periodic cell DTX pattern and the RAR window is running, monitor a physical downlink control channel (PDCCH) of the SpCell.

In another embodiment, a base station (BS) is provided. The BS includes a processor configured to determine whether at least one serving cell is configured with a periodic cell DTX pattern. The BS also includes a transceiver operably coupled to the processor. The transceiver is configured to transmit a RRC reconfiguration message including the configuration of the periodic cell DTX pattern for the at least one serving cell.

In yet another embodiment, a method of operating a UE is provided. The method includes receiving a RRC reconfiguration message including a configuration of a periodic cell DTX pattern for at least one serving cell, determining whether a SpCell is configured with the periodic cell DTX pattern, and determining whether a RAR window is running. The method also includes, based on a determination that the SpCell is configured with the periodic cell DTX pattern and the RAR window is running, monitoring a PDCCH of the SpCell.

Other technical features may be readily apparent to one skilled in the art from the following figures, descriptions, and claims.

Before undertaking the DETAILED DESCRIPTION below, it may be advantageous to set forth definitions of certain words and phrases used throughout this patent document. The term “couple” and its derivatives refer to any direct or indirect communication between two or more elements, whether or not those elements are in physical contact with one another. The terms “transmit,” “receive,” and “communicate,” as well as derivatives thereof, encompass both direct and indirect communication. The terms “include” and “comprise,” as well as derivatives thereof, mean inclusion without limitation. The term “or” is inclusive, meaning and/or. The phrase “associated with,” as well as derivatives thereof, means to include, be included within, interconnect with, contain, be contained within, connect to or with, couple to or with, be communicable with, cooperate with, interleave, juxtapose, be proximate to, be bound to or with, have, have a property of, have a relationship to or with, or the like. The term “controller” means any device, system or part thereof that controls at least one operation. Such a controller may be implemented in hardware or a combination of hardware and software and/or firmware. The functionality associated with any particular controller may be centralized or distributed, whether locally or remotely. The phrase “at least one of,” when used with a list of items, means that different combinations of one or more of the listed items may be used, and only one item in the list may be needed. For example, “at least one of: A, B, and C” includes any of the following combinations: A, B, C, A and B, A and C, B and C, and A and B and C.

Moreover, various functions described below can be implemented or supported by one or more computer programs, each of which is formed from computer readable program code and embodied in a computer readable medium. The terms “application” and “program” refer to one or more computer programs, software components, sets of instructions, procedures, functions, objects, classes, instances, related data, or a portion thereof adapted for implementation in a suitable computer readable program code. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device.

Definitions for other certain words and phrases are provided throughout this patent document. Those of ordinary skill in the art should understand that in many if not most instances, such definitions apply to prior as well as future uses of such defined words and phrases.

### BRIEF DESCRIPTION OF THE DRAWINGS

For a more complete understanding of this disclosure and its advantages, reference is now made to the following description, taken in conjunction with the accompanying drawings, in which:

FIG. 1 illustrates an example wireless network according to embodiments of the present disclosure;

FIGS. 2A and 2B illustrate example wireless transmit and receive paths according to embodiments of the present disclosure;

FIG. 3A illustrates an example UE according to embodiments of the present disclosure;

FIG. 3B illustrates an example gNB according to embodiments of the present disclosure;

FIG. 4 illustrates an example UE operation for SR transmission during a Cell DRX non-active period according to embodiments of the present disclosure;

FIG. 5 illustrates another example UE operation for SR transmission during a Cell DRX non-active period according to embodiments of the present disclosure;

FIG. 6 illustrates an example UE operation for random access during a Cell DRX non-active period according to embodiments of the present disclosure;

FIG. 7 illustrates an example UE operation for PUCCH Cell change during a Cell DRX non-active period according to embodiments of the present disclosure; and

FIG. 8 illustrates an example method for energy saving in a wireless network according to embodiments of the present disclosure.

### DETAILED DESCRIPTION

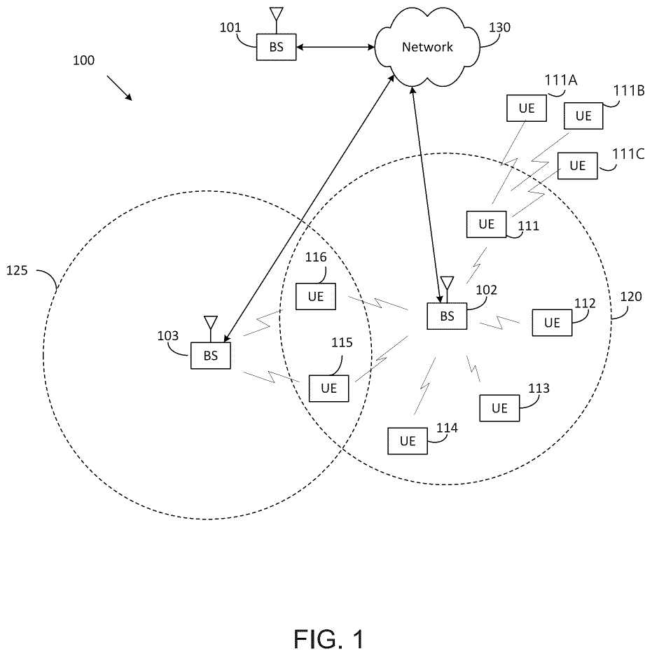

FIGS. 1 through 8, discussed below, and the various embodiments used to describe the principles of this disclosure in this patent document are by way of illustration only and should not be construed in any way to limit the scope of the disclosure. Those skilled in the art will understand that the principles of this disclosure may be implemented in any suitably arranged wireless communication system.

To meet the demand for wireless data traffic having increased since deployment of 4G communication systems and to enable various vertical applications, 5G/NR communication systems have been developed and are currently being deployed. The 5G/NR communication system is considered to be implemented in higher frequency (mmWave) bands, e.g., 28 GHz or 60 GHz bands, so as to accomplish higher data rates or in lower frequency bands, such as 6 GHz, to enable robust coverage and mobility support. To decrease propagation loss of the radio waves and increase the transmission distance, the beamforming, massive multiple-input multiple-output (MIMO), full dimensional MIMO (FD-MIMO), array antenna, an analog beam forming, large scale antenna techniques are discussed in 5G/NR communication systems.

In addition, in 5G/NR communication systems, development for system network improvement is under way based on advanced small cells, cloud radio access networks (RANs), ultra-dense networks, device-to-device (D2D) communication, wireless backhaul, moving network, cooperative communication, coordinated multi-points (CoMP), reception-end interference cancelation and the like.

The discussion of 5G systems and frequency bands associated therewith is for reference as certain embodiments of the present disclosure may be implemented in 5G systems. However, the present disclosure is not limited to 5G systems or the frequency bands associated therewith, and embodiments of the present disclosure may be utilized in connection with any frequency band. For example, aspects of the present disclosure may also be applied to deployment of 5G communication systems, 6G or even later releases which may use terahertz (THz) bands.

FIGS. 1-3B below describe various embodiments implemented in wireless communications systems and with the use of orthogonal frequency division multiplexing (OFDM) or orthogonal frequency division multiple access (OFDMA) communication techniques. The descriptions of FIGS. 1-3B are not meant to imply physical or architectural limitations to the manner in which different embodiments may be implemented. Different embodiments of the present disclosure may be implemented in any suitably arranged communications system.

FIG. 1 illustrates an example wireless network 100 according to embodiments of the present disclosure. The embodiment of the wireless network shown in FIG. 1 is for illustration only. Other embodiments of the wireless network 100 could be used without departing from the scope of this disclosure.

As shown in FIG. 1, the wireless network includes a gNB 101 (e.g., base station, BS), a gNB 102, and a gNB 103. The gNB 101 communicates with the gNB 102 and the gNB 103. The gNB 101 also communicates with at least one network 130, such as the Internet, a proprietary Internet Protocol (IP) network, or other data network.

The gNB 102 provides wireless broadband access to the network 130 for a first plurality of user equipments (UEs) within a coverage area 120 of the gNB 102. The first plurality of UEs includes a UE 111, which may be located in a small business; a UE 112, which may be located in an enterprise; a UE 113, which may be a WiFi hotspot; a UE 114, which may be located in a first residence; a UE 115, which may be located in a second residence; and a UE 116, which may be a mobile device, such as a cell phone, a wireless laptop, a wireless PDA, or the like. The gNB 103 provides wireless broadband access to the network 130 for a second plurality of UEs within a coverage area 125 of the gNB 103. The second plurality of UEs includes the UE 115 and the UE 116. In some embodiments, one or more of the gNBs 101-103 may communicate with each other and with the UEs 111-116 using 5G/NR, longterm evolution (LTE), longterm evolution-advanced (LTE-A), WiMAX, WiFi, or other wireless communication techniques.

In another example, the UE 116 may be within network coverage and the other UE may be outside network coverage (e.g., UEs 111A-111C). In yet another example, both UEs are outside network coverage. In some embodiments, one or more of the gNBs 101-103 may communicate with each other and with the UEs 111-116 using 5G/NR, LTE, LTE-A, WiMAX, WiFi, or other wireless communication techniques. In some embodiments, the UEs 111-116 may use a device to device (D2D) interface called PC5 (e.g., also known as sidelink at the physical layer) for communication.

Depending on the network type, the term “base station” or “BS” can refer to any component (or collection of components) configured to provide wireless access to a network, such as transmit point (TP), transmit-receive point (TRP), an enhanced base station (eNodeB or eNB), a 5G/NR base station (gNB), a macrocell, a femtocell, a WiFi access point (AP), or other wirelessly enabled devices. Base stations may provide wireless access in accordance with one or more wireless communication protocols, e.g., 5G/NR 3^{rd} generation partnership project (3GPP) NR, long term evolution (LTE), LTE advanced (LTE-A), high speed packet access (HSPA), Wi-Fi 802.11a/b/g/n/ac, etc. For the sake of convenience, the terms “BS” and “TRP” are used interchangeably in this patent document to refer to network infrastructure components that provide wireless access to remote terminals. Also, depending on the network type, the term “user equipment” or “UE” can refer to any component such as “mobile station,” “subscriber station,” “remote terminal,” “wireless terminal,” “receive point,” or “user device.” For the sake of convenience, the terms “user equipment” and “UE” are used in this patent document to refer to remote wireless equipment that wirelessly accesses a BS, whether the LUE is a mobile device (such as a mobile telephone or smartphone) or is normally considered a stationary device (such as a desktop computer or vending machine).

Dotted lines show the approximate extents of the coverage areas 120 and 125, which are shown as approximately circular for the purposes of illustration and explanation only. It should be clearly understood that the coverage areas associated with gNBs, such as the coverage areas 120 and 125, may have other shapes, including irregular shapes, depending upon the configuration of the gNBs and variations in the radio environment associated with natural and man-made obstructions.

As described in more detail below, one or more of the UEs 111-116 include circuitry, programing, or a combination thereof, for energy saving in wireless communication systems. In certain embodiments, one or more of the gNBs 101-103 includes circuitry, programing, or a combination thereof, to support energy saving in wireless communication systems.

Although FIG. 1 illustrates one example of a wireless network, various changes may be made to FIG. 1. For example, the wireless network could include any number of gNBs and any number of UEs in any suitable arrangement. Also, the gNB 101 could communicate directly with any number of UEs and provide those UEs with wireless broadband access to the network 130. Similarly, each gNB 102-103 could communicate directly with the network 130 and provide UEs with direct wireless broadband access to the network 130. Further, the gNBs 101, 102, and/or 103 could provide access to other or additional external networks, such as external telephone networks or other types of data networks.

As discussed in greater detail below, the wireless network 100 may have communications facilitated via one or more devices (e.g., UEs 111A to 111C) that may have a SL communication with the UE 111. The UE 111 can communicate directly with the UEs 111A to 111C through a set of SLs (e.g., SL interfaces) to provide sideline communication, for example, in situations where the UEs 111A to 111C are remotely located or otherwise in need of facilitation for network access connections (e.g., BS 102) beyond or in addition to traditional fronthaul and/or backhaul connections/interfaces. In one example, the UE 111 can have direct communication, through the SL communication, with UEs 111A to 111C with or without support by the BS 102. Various of the UEs (e.g., as depicted by UEs 112 to 116) may be capable of one or more communication with their other UEs (such as UEs 111A to 111C as for UE 111).

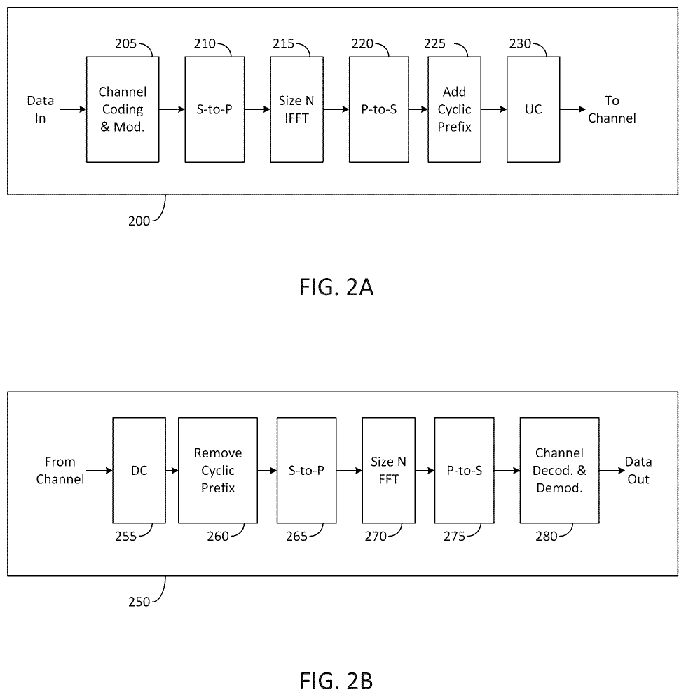

FIGS. 2A and 2B illustrate example wireless transmit and receive paths according to embodiments of the present disclosure. In the following description, a transmit path 200 may be described as being implemented in a gNB (such as gNB 102), while a receive path 250 may be described as being implemented in a UE (such as UE 116). However, it will be understood that the receive path 250 can be implemented in a gNB and that the transmit path 200 can be implemented in a UE. In some embodiments, the transmit path 200 and/or the receive path 250 is configured to implement and/or support energy saving in wireless communication systems as described in embodiments of the present disclosure.

The transmit path 200 includes a channel coding and modulation block 205, a serial-to-parallel (S-to-P) block 210, a size N Inverse Fast Fourier Transform (IFFT) block 215, a parallel-to-serial (P-to-S) block 220, an add cyclic prefix block 225, and an up-converter (UC) 230. The receive path 250 includes a down-converter (DC) 255, a remove cyclic prefix block 260, a serial-to-parallel (S-to-P) block 265, a size N Fast Fourier Transform (FFT) block 270, a parallel-to-serial (P-to-S) block 275, and a channel decoding and demodulation block 280.

In the transmit path 200, the channel coding and modulation block 205 receives a set of information bits, applies coding (such as a low-density parity check (LDPC) coding), and modulates the input bits (such as with Quadrature Phase Shift Keying (QPSK) or Quadrature Amplitude Modulation (QAM)) to generate a sequence of frequency-domain modulation symbols. The serial-to-parallel block 210 converts (such as de-multiplexes) the serial modulated symbols to parallel data in order to generate N parallel symbol streams, where N is the IFFT/FFT size used in the gNB 102 and the UE 116. The size N IFFT block 215 performs an IFFT operation on the N parallel symbol streams to generate time-domain output signals. The parallel-to-serial block 220 converts (such as multiplexes) the parallel time-domain output symbols from the size N IFFT block 215 in order to generate a serial time-domain signal. The add cyclic prefix block 225 inserts a cyclic prefix to the time-domain signal. The up-converter 230 modulates (such as up-converts) the output of the add cyclic prefix block 225 to an RF frequency for transmission via a wireless channel. The signal may also be filtered at baseband before conversion to the RF frequency.

A transmitted RF signal from the gNB 102 arrives at the UE 116 after passing through the wireless channel, and reverse operations to those at the gNB 102 are performed at the UE 116. The down-converter 255 down-converts the received signal to a baseband frequency, and the remove cyclic prefix block 260 removes the cyclic prefix to generate a serial time-domain baseband signal. The serial-to-parallel block 265 converts the time-domain baseband signal to parallel time domain signals. The size N FFT block 270 performs an FFT algorithm to generate N parallel frequency-domain signals. The parallel-to-serial block 275 converts the parallel frequency-domain signals to a sequence of modulated data symbols. The channel decoding and demodulation block 280 demodulates and decodes the modulated symbols to recover the original input data stream.

Each of the gNBs 101-103 may implement a transmit path 200 that is analogous to transmitting in the downlink to UEs 111-116 and may implement a receive path 250 that is analogous to receiving in the uplink from UEs 111-116. Similarly, each of UEs 111-116 may implement a transmit path 200 for transmitting in the uplink to gNBs 101-103 and may implement a receive path 250 for receiving in the downlink from gNBs 101-103.

Each of the components in FIGS. 2A and 2B can be implemented using only hardware or using a combination of hardware and software/firmware. As a particular example, at least some of the components in FIGS. 2A and 2B may be implemented in software, while other components may be implemented by configurable hardware or a mixture of software and configurable hardware. For instance, the FFT block 270 and the IFFT block 215 may be implemented as configurable software algorithms, where the value of size N may be modified according to the implementation.

Furthermore, although described as using FFT and IFFT, this is by way of illustration only and should not be construed to limit the scope of this disclosure. Other types of transforms, such as Discrete Fourier Transform (DFT) and Inverse Discrete Fourier Transform (IDFT) functions, can be used. It will be appreciated that the value of the variable N may be any integer number (such as 1, 2, 3, 4, or the like) for DFT and IDFT functions, while the value of the variable N may be any integer number that is a power of two (such as 1, 2, 4, 8, 16, or the like) for FFT and IFFT functions.

Although FIGS. 2A and 2B illustrate examples of wireless transmit and receive paths, various changes may be made to FIGS. 2A and 2B. For example, various components in FIGS. 2A and 2B can be combined, further subdivided, or omitted and additional components can be added according to particular needs. Also, FIGS. 2A and 2B are meant to illustrate examples of the types of transmit and receive paths that can be used in a wireless network. Any other suitable architectures can be used to support wireless communications in a wireless network.

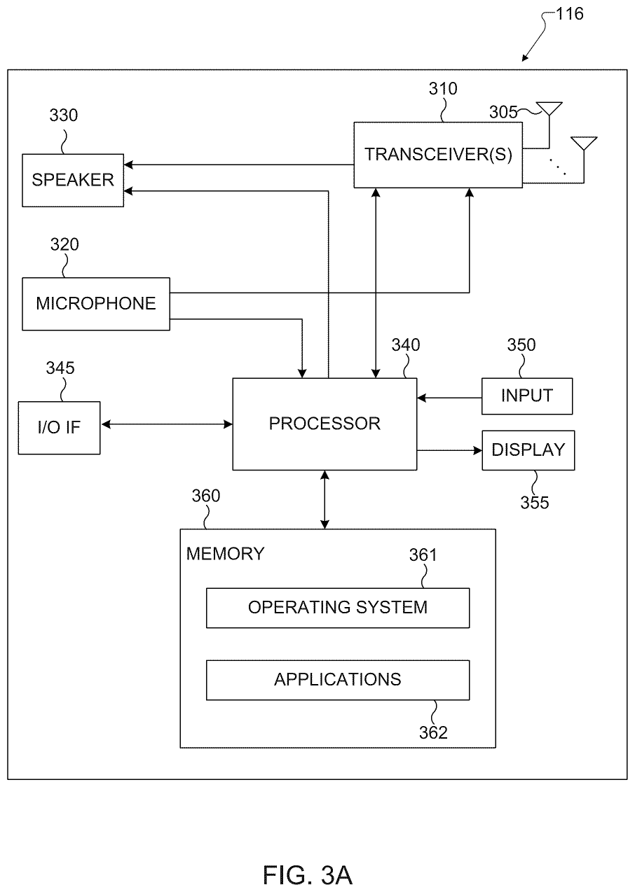

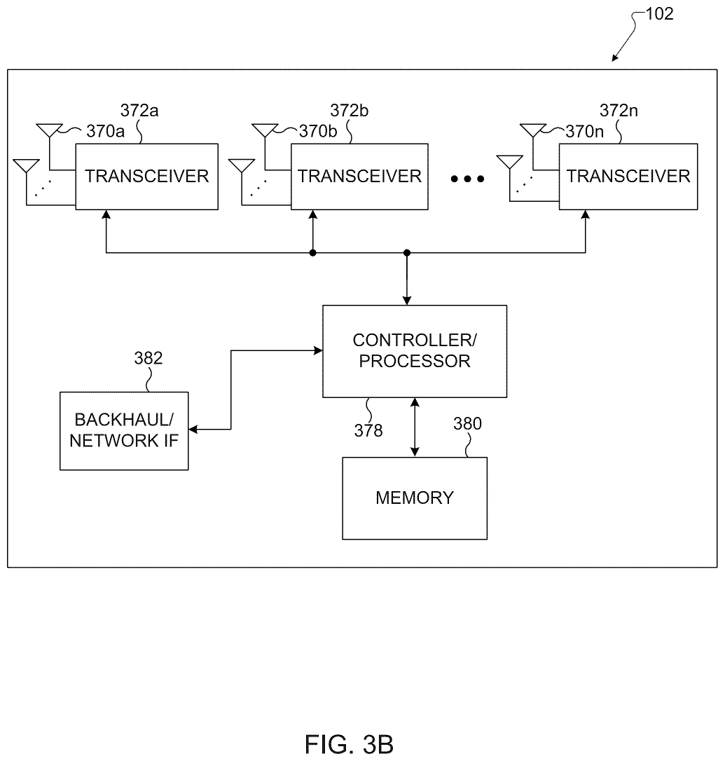

FIG. 3A illustrates an example UE 116 according to embodiments of the present disclosure. The embodiment of the UE 116 illustrated in FIG. 3A is for illustration only, and the UEs 111-115 of FIG. 1 could have the same or similar configuration. However, UEs come in a wide variety of configurations, and FIG. 3A does not limit the scope of this disclosure to any particular implementation of a UE.

As shown in FIG. 3A, the UE 116 includes antenna(s) 305, a transceiver(s) 310, and a microphone 320. The UE 116 also includes a speaker 330, a processor 340, an input/output (I/O) interface (IF) 345, an input 350, a display 355, and a memory 360. The memory 360 includes an operating system (OS) 361 and one or more applications 362.

The transceiver(s) 310 receives, from the antenna 305, an incoming RF signal transmitted by a gNB of the network 100. The transceiver(s) 310 down-converts the incoming RF signal to generate an intermediate frequency (IF) or baseband signal. The IF or baseband signal is processed by RX processing circuitry in the transceiver(s) 310 and/or processor 340, which generates a processed baseband signal by filtering, decoding, and/or digitizing the baseband or IF signal. The RX processing circuitry sends the processed baseband signal to the speaker 330 (such as for voice data) or is processed by the processor 340 (such as for web browsing data).

TX processing circuitry in the transceiver(s) 310 and/or processor 340 receives analog or digital voice data from the microphone 320 or other outgoing baseband data (such as web data, e-mail, or interactive video game data) from the processor 340. The TX processing circuitry encodes, multiplexes, and/or digitizes the outgoing baseband data to generate a processed baseband or IF signal. The transceiver(s) 310 up-converts the baseband or IF signal to an RF signal that is transmitted via the antenna(s) 305.

The processor 340 can include one or more processors or other processing devices and execute the OS 361 stored in the memory 360 in order to control the overall operation of the UE 116. For example, the processor 340 could control the reception of DL channel signals and the transmission of UL channel signals by the transceiver(s) 310 in accordance with well-known principles. In some embodiments, the processor 340 includes at least one microprocessor or microcontroller.

The processor 340 is also capable of executing other processes and programs resident in the memory 360, for example, processes for energy saving in wireless communication systems as discussed in greater detail below. The processor 340 can move data into or out of the memory 360 as required by an executing process. In some embodiments, the processor 340 is configured to execute the applications 362 based on the OS 361 or in response to signals received from gNBs or an operator. The processor 340 is also coupled to the I/O interface 345, which provides the UE 116 with the ability to connect to other devices, such as laptop computers and handheld computers. The I/O interface 345 is the communication path between these accessories and the processor 340.

The processor 340 is also coupled to the input 350, which includes for example, a touchscreen, keypad, etc., and the display 355. The operator of the UE 116 can use the input 350 to enter data into the UE 116. The display 355 may be a liquid crystal display, light emitting diode display, or other display capable of rendering text and/or at least limited graphics, such as from web sites.

The memory 360 is coupled to the processor 340. Part of the memory 360 could include a random-access memory (RAM), and another part of the memory 360 could include a Flash memory or other read-only memory (ROM).

Although FIG. 3A illustrates one example of UE 116, various changes may be made to FIG. 3A. For example, various components in FIG. 3A could be combined, further subdivided, or omitted and additional components could be added according to particular needs. As a particular example, the processor 340 could be divided into multiple processors, such as one or more central processing units (CPUs) and one or more graphics processing units (GPUs). In another example, the transceiver(s) 310 may include any number of transceivers and signal processing chains and may be connected to any number of antennas. Also, while FIG. 3A illustrates the UE 116 configured as a mobile telephone or smartphone, UEs could be configured to operate as other types of mobile or stationary devices.

FIG. 3B illustrates an example gNB 102 according to embodiments of the present disclosure. The embodiment of the gNB 102 illustrated in FIG. 3B is for illustration only, and the gNBs 101 and 103 of FIG. 1 could have the same or similar configuration. However, gNBs come in a wide variety of configurations, and FIG. 3B does not limit the scope of this disclosure to any particular implementation of a gNB.

As shown in FIG. 3B, the gNB 102 includes multiple antennas 370a-370n, multiple transceivers 372a-372n, a controller/processor 378, a memory 380, and a backhaul or network interface 382.

The transceivers 372a-372n receive, from the antennas 370a-370n, incoming RF signals, such as signals transmitted by UEs in the network 100. The transceivers 372a-372n down-convert the incoming RF signals to generate IF or baseband signals. The IF or baseband signals are processed by receive (RX) processing circuitry in the transceivers 372a-372n and/or controller/processor 378, which generates processed baseband signals by filtering, decoding, and/or digitizing the baseband or IF signals. The controller/processor 378 may further process the baseband signals.

Transmit (TX) processing circuitry in the transceivers 372a-372n and/or controller/processor 378 receives analog or digital data (such as voice data, web data, e-mail, or interactive video game data) from the controller/processor 378. The TX processing circuitry encodes, multiplexes, and/or digitizes the outgoing baseband data to generate processed baseband or IF signals. The transceivers 372a-372n up-converts the baseband or IF signals to RF signals that are transmitted via the antennas 370a-370n.

The controller/processor 378 can include one or more processors or other processing devices that control the overall operation of the gNB 102. For example, the controller/processor 378 could control the reception of uplink (UL) channel signals and the transmission of downlink (DL) channel signals by the transceivers 372a-372n in accordance with well-known principles. The controller/processor 378 could support additional functions as well, such as more advanced wireless communication functions. For instance, the controller/processor 378 could support beam forming or directional routing operations in which outgoing/incoming signals from/to multiple antennas 370a-370n are weighted differently to effectively steer the outgoing signals in a desired direction. Any of a wide variety of other functions could be supported in the gNB 102 by the controller/processor 378.

The controller/processor 378 is also capable of executing programs and other processes resident in the memory 380, such as an OS and, for example, processes to support energy saving in wireless communication systems as discussed in greater detail below. The controller/processor 378 can move data into or out of the memory 380 as required by an executing process.

The controller/processor 378 is also coupled to the backhaul or network interface 382. The backhaul or network interface 382 allows the gNB 102 to communicate with other devices or systems over a backhaul connection or over a network. The interface 382 could support communications over any suitable wired or wireless connection(s). For example, when the gNB 102 is implemented as part of a cellular communication system (such as one supporting 5G/NR, LTE, or LTE-A), the interface 382 could allow the gNB 102 to communicate with other gNBs over a wired or wireless backhaul connection. When the gNB 102 is implemented as an access point, the interface 382 could allow the gNB 102 to communicate over a wired or wireless local area network or over a wired or wireless connection to a larger network (such as the Internet). The interface 382 includes any suitable structure supporting communications over a wired or wireless connection, such as an Ethernet or transceiver.

The memory 380 is coupled to the controller/processor 378. Part of the memory 380 could include a RAM, and another part of the memory 380 could include a Flash memory or other ROM.

Although FIG. 3B illustrates one example of gNB 102, various changes may be made to FIG. 3B. For example, the gNB 102 could include any number of each component shown in FIG. 3B. Also, various components in FIG. 3B could be combined, further subdivided, or omitted and additional components could be added according to particular needs.

The next generation wireless communication system (e.g., 5G, beyond 5G, 6G) supports not only lower frequency bands but also higher frequency (mmWave) bands, e.g., 10 GHz to 100 GHz bands, so as to accomplish higher data rates. To mitigate propagation loss of radio waves and increase the transmission distance, beamforming, massive Multiple-Input Multiple-Output (MIMO), Full Dimensional MIMO (FD-MIMO), array antenna, analog beam forming, and large scale antenna techniques are being considered in the design of the fifth generation wireless communication system. In addition, the fifth generation wireless communication system is expected to address different use cases having quite different requirements in terms of data rate, latency, reliability, mobility etc. However, it is expected that the design of the air-interface of the fifth generation wireless communication system would be flexible enough to serve UEs having quite different capabilities depending on the use case and market segment the UE caters to service the end customer. A few example use cases the fifth generation wireless communication system wireless system is expected to address is enhanced Mobile Broadband (eMBB), massive Machine Type Communication (m-MTC), ultra-reliable low latency communication (URLL) etc. The eMBB requirements like tens of Gbps data rate, low latency, high mobility, etc. address the market segment representing the conventional wireless broadband subscribers needing internet connectivity everywhere, all the time and on the go. The m-MTC requirements like very high connection density, infrequent data transmission, very long battery life, low mobility, etc. address the market segment representing the Internet of Things (IoT)/Internet of Everything (IoE) envisioning connectivity of billions of devices. The URLL requirements like very low latency, very high reliability and variable mobility, etc. address the market segment representing industrial automation applications, and vehicle-to-vehicle/vehicle-to-infrastructure communication foreseen as one of the enablers for autonomous cars.

In the next generation wireless communication system (e.g., 5G, beyond 5G, 6G) operating in higher frequency (e.g., mmWave, terahertz) bands, UEs and gNBs communicate with each other using Beamforming. Beamforming techniques are used to mitigate the propagation path losses and to increase the propagation distance for communication at higher frequency bands. Beamforming enhances the transmission and reception performance using a high-gain antenna. Beamforming can be classified into Transmission (TX) beamforming performed in a transmitting end and reception (RX) beamforming performed in a receiving end. In general, TX beamforming increases directivity by allowing an area in which propagation reaches to be densely located in a specific direction by using a plurality of antennas. In this situation, aggregation of the plurality of antennas can be referred to as an antenna array, and each antenna included in the array can be referred to as an array element. The antenna array can be configured in various forms such as a linear array, a planar array, etc. The use of TX beamforming results in an increase in the directivity of a signal, thereby increasing a propagation distance. Further, since the signal is almost not transmitted in a direction other than a directivity direction, a signal interference acting on another receiving end is significantly decreased. The receiving end can perform beamforming on a RX signal by using a RX antenna array. RX beamforming increases the RX signal strength transmitted in a specific direction by allowing propagation to be concentrated in a specific direction, and excludes a signal transmitted in a direction other than the specific direction from the RX signal, thereby providing an effect of blocking an interference signal. By using beamforming techniques, a transmitter can generate a plurality of transmit beam patterns of different directions. Each of these transmit beam patterns can be also referred as a transmit (TX) beam. Wireless communication system operating at high frequency use a plurality of narrow TX beams to transmit signals in the cell as each narrow TX beam provides coverage to a part of the cell. The narrower the TX beam, the higher the antenna gain and hence the larger the propagation distance of a signal transmitted using beamforming. A receiver can also generate a plurality of receive (RX) beam patterns of different directions. Each of these receive patterns can be also referred as a receive (RX) beam.

The next generation wireless communication system (e.g., 5G, beyond 5G, 6G) supports a standalone mode of operation as well dual connectivity (DC). In DC a multiple Rx/Tx UE may be configured to utilize resources provided by two different nodes (or NBs) connected via non-ideal backhaul. One node acts as the Master Node (MN) and the other as the Secondary Node (SN). The MN and SN are connected via a network interface and at least the MN is connected to the core network. NR also supports Multi-RAT Dual Connectivity (MR-DC) operation whereby a UE in an RRC_CONNECTED state is configured to utilize radio resources provided by two distinct schedulers, located in two different nodes connected via a non-ideal backhaul and providing either E-UTRA (i.e., if the node is an ng-eNB) or NR access (i.e., if the node is a gNB). In NR for a UE in an RRC_CONNECTED state not configured with CA/DC there is only one serving cell comprising the primary cell (PCell). For a UE in an RRC_CONNECTED state configured with CA/DC the term ‘serving cells’ is used to denote the set of cells comprising Special Cell(s) and all secondary cells. In NR the term Master Cell Group (MCG) refers to a group of serving cells associated with the Master Node, comprising the PCell and optionally one or more Secondary Cells (SCells). In NR the term Secondary Cell Group (SCG) refers to a group of serving cells associated with the Secondary Node, comprising the Primary SCG Cell (PSCell) and optionally one or more SCells. In NR, a PCell refers to a serving cell in MCG, operating on the primary frequency, in which the UE either performs the initial connection establishment procedure or initiates the connection re-establishment procedure. In NR for a UE configured with CA, an SCell is a cell providing additional radio resources on top of a SpCell. PSCell refers to a serving cell in a SCG in which the UE performs random access when performing the Reconfiguration with Sync procedure. For Dual Connectivity operation the term SpCell refers to the PCell of the MCG or the PSCell of the SCG, otherwise the term SpCell refers to the PCell.

In the next generation wireless communication system (e.g., 5G, beyond 5G, 6G), a node B (gNB) or base station in cell broadcast Synchronization Signal and PBCH block (SSB) includes primary and secondary synchronization signals (PSS, SSS) and system information. System information includes common parameters needed to communicate in cell. In the next generation wireless communication system, System Information (SI) is divided into the MIB and a number of SIBs where: the MIB is always transmitted on the BCH with a periodicity of 80 ms and repetitions made within 80 ms and the MIB includes parameters that are used to acquire a SIB1 from the cell. The SIB1 is transmitted on the DL-SCH with a periodicity of 160 ms and variable transmission repetition. The default transmission repetition periodicity of SIB1 is 20 ms but the actual transmission repetition periodicity is up to network implementation. For SSB and CORESET multiplexing pattern 1, the SIB1 repetition transmission period is 20 ms. For SSB and CORESET multiplexing pattern 2/3, the SIB1 transmission repetition period is the same as the SSB period. SIB1 includes information regarding the availability and scheduling (e.g., mapping of SIBs to SI message, periodicity, SI-window size) of other SIBs with an indication whether one or more SIBs are only provided on-demand and, in that case, the configuration needed by the UE to perform the SI request. SIB1 is a cell-specific SIB. SIBs other than SIB1 and posSIBs are carried in SystemInformation (SI) messages, which are transmitted on the DL-SCH. Only SIBs or posSIBs having the same periodicity can be mapped to the same SI message. SIBs and posSIBs are mapped to the different SI messages. Each SI message is transmitted within periodically occurring time domain windows (referred to as SI-windows with same length for all SI messages). Each SI message is associated with an SI-window and the SI-windows of different SI messages do not overlap. That is, within one SI-window only the corresponding SI message is transmitted. An SI message may be transmitted a number of times within the SI-window. Any SIB or posSIB except SIB1 can be configured to be cell specific or area specific, using an indication in SIB1. A cell specific SIB is applicable only within a cell that provides the SIB while an area specific SIB is applicable within an area referred to as an SI area, which comprises one or several cells and is identified by systemInformationAreaID; The mapping of SIBs to SI messages is configured in schedulingInfoList, while the mapping of posSIBs to SI messages is configured in pos-SchedulingInfoList. Each SIB is contained only in a single SI message and each SIB and posSIB is contained at most once in that SI message. For a UE in an RRC_CONNECTED state, the network can provide system information through dedicated signaling using the RRCReconfiguration message, e.g., if the UE has an active BWP with no common search space configured to monitor system information, paging, or upon request from the UE. In ab RRC_CONNECTED state, the UE needs to acquire the required SIB(s) only from the PCell. For PSCell and SCells, the network provides the required SI by dedicated signaling, i.e., within an RRCReconfiguration message. Nevertheless, the UE shall acquire the MIB of the PSCell to get SFN timing of the SCG (which may be different from the MCG). Upon change of relevant SI for the SCell, the network releases and adds the concerned SCell. For a PSCell, the required SI can only be changed with Reconfiguration with Sync.

In the next generation wireless communication system (e.g., 5G, beyond 5G, 6G), a Physical Downlink Control Channel (PDCCH) is used to schedule DL transmissions on a PDSCH and UL transmissions on a PUSCH, where the Downlink Control Information (DCI) on the PDCCH includes: downlink assignments containing at least modulation and coding format, resource allocation, and hybrid-ARQ information related to DL-SCH; and uplink scheduling grants containing at least modulation and coding format, resource allocation, and hybrid-ARQ information related to UL-SCH. In addition to scheduling, the PDCCH can be used for: activation and deactivation of a configured PUSCH transmission with a configured grant; activation and deactivation of a PDSCH semi-persistent transmission; notifying one or more UEs of the slot format; notifying one or more UEs of the PRB(s) and OFDM symbol(s) where the UE may assume no transmission is intended for the UE; transmission of TPC commands for the physical uplink control channel (PUCCH) and physical uplink shared channel (PUSCH); transmission of one or more TPC commands for SRS transmissions by one or more UEs; switching a UE's active bandwidth part; and initiating a random access procedure. A UE monitors a set of PDCCH candidates in the configured monitoring occasions in one or more configured Control REsource SETs (CORESETs) according to the corresponding search space configurations. A CORESET comprises a set of PRBs with a time duration of 1 to 3 OFDM symbols. The resource units Resource Element Groups (REGs) and Control Channel Elements (CCEs) are defined within a CORESET with each CCE comprising a set of REGs. Control channels are formed by aggregation of CCE. Different code rates for the control channels are realized by aggregating different numbers of CCEs. Interleaved and non-interleaved CCE-to-REG mapping is supported in a CORESET. Polar coding is used for the PDCCH. Each resource element group carrying the PDCCH carries its own DMRS. QPSK modulation is used for the PDCCH.

In the next generation wireless communication system (e.g., 5G, beyond 5G, 6G), a list of search space configurations is signaled by the gNB for each configured BWP of the serving cell, wherein each search configuration is uniquely identified by a search space identifier. The search space identifier is unique amongst the BWPs of a serving cell. An identifier of a search space configuration to be used for a specific purpose such as paging reception, SI reception, random access response reception is explicitly signaled by the gNB for each configured BWP. In NR, the search space configuration comprises the parameters Monitoring-periodicity-PDCCH-slot, Monitoring-offset-PDCCH-slot, Monitoring-symbols-PDCCH-within-slot and duration. A UE determines the PDCCH monitoring occasion(s) within a slot using the parameters PDCCH monitoring periodicity (Monitoring-periodicity-PDCCH-slot), PDCCH monitoring offset (Monitoring-offset-PDCCH-slot), and PDCCH monitoring pattern (Monitoring-symbols-PDCCH-within-slot). PDCCH monitoring occasions are in slots ‘x’ to x+duration where the slot with number ‘x’ in a radio frame with number ‘y’ satisfies the equation below:

(y*(number of slots in a radio frame)+x−Monitoring-offset-PDCCH-slot) mod (Monitoring-periodicity-PDCCH-slot)=0;

The starting symbol of a PDCCH monitoring occasion in each slot having a PDCCH monitoring occasion is given by Monitoring-symbols-PDCCH-within-slot. The length (in symbols) of a PDCCH monitoring occasion is given in the CORESET associated with the search space. The search space configuration includes the identifier of the CORESET configuration associated with the search space. A list of CORESET configurations are signaled by the gNB for each configured BWP of the serving cell, wherein each coreset configuration is uniquely identified by a CORESET identifier. The CORESET identifier is unique amongst the BWPs of a serving cell. Note that each radio frame is of 10 ms duration. Each radio frame is identified by a radio frame number or system frame number. Each radio frame comprises several slots wherein, the number of slots in a radio frame and duration of slots depends on sub carrier spacing. The number of slots in a radio frame and duration of slots for each supported SCS is pre-defined in NR. Each CORESET configuration is associated with a list of Transmission configuration indicator (TCI) states. One DL RS ID (SSB or CSI RS) is configured per TCI state. The list of TCI states corresponding to a CORESET configuration is signaled by the gNB via RRC signaling. One of the TCI states in the TCI state list is activated and indicated to the UE by the gNB. The TCI state indicates the DL TX beam (the DL TX beam is QCLed with the SSB/CSI RS of the TCI state) used by the gNB for transmission of the PDCCH in the PDCCH monitoring occasions of a search space.

In the next generation wireless communication system (e.g., 5G, beyond 5G, 6G) bandwidth adaptation (BA) is supported. With BA, the receive and transmit bandwidth of a UE need not be as large as the bandwidth of the cell and can be adjusted: the width can be ordered to change (e.g., to shrink during a period of low activity to save power); the location can move in the frequency domain (e.g., to increase scheduling flexibility); and the subcarrier spacing can be ordered to change (e.g., to allow different services). A subset of the total cell bandwidth of a cell is referred to as a Bandwidth Part (BWP). BA is achieved by configuring an RRC connected UE with BWP(s) and telling the UE which of the configured BWPs is currently the active BWP. When BA is configured, the UE only has to monitor the PDCCH on the one active BWP. That is, the UE does not have to monitor the PDCCH on the entire DL frequency of the serving cell. In an RRC connected state, the UE is configured with one or more DL and UL BWPs, for each configured Serving Cell (i.e., PCell or SCell). For an activated Serving Cell, there is always one active UL and DL BWP at any point in time. BWP switching for a Serving Cell is used to activate an inactive BWP and deactivate an active BWP at a time. BWP switching is controlled by the PDCCH indicating a downlink assignment or an uplink grant, by the bwp-InactivityTimer, by RRC signaling, or by the MAC entity itself upon initiation of a Random-Access procedure. Upon addition of an SpCell or activation of an SCell, the DL BWP and UL BWP indicated by firstActiveDownlinkBWP-Id and firstActiveUplinkBWP-Id respectively is active without receiving PDCCH indicating a downlink assignment or an uplink grant. The active BWP for a Serving Cell is indicated by either RRC or PDCCH. For unpaired spectrum, a DL BWP is paired with a UL BWP, and BWP switching is common for both UL and DL. Upon expiry of the BWP inactivity timer, the UE switches the active DL BWP to the default DL BWP or initial DL BWP (if a default DL BWP is not configured).

In the next generation wireless communication system (e.g., 5G, beyond 5G, 6G), random access (RA) is supported. RA is used to achieve uplink (UL) time synchronization. RA is used during initial access, handover, radio resource control (RRC) connection re-establishment procedure, scheduling request transmission, secondary cell group (SCG) addition/modification, beam failure recovery and data or control information transmission in UL by a non-synchronized UE in an RRC CONNECTED state. Several types of random-access procedures are supported such as contention based random access, and contention free random access, and each of these can be one of 2 step or 4 step random access.

In contention based random access (CBRA), also referred to as 4 step CBRA, the UE first transmits a Random Access preamble (also referred as Msg1) and then waits for a Random access response (RAR) in the RAR window. The RAR is also referred to as Msg2. A next generation node B (gNB) transmits the RAR on a physical downlink shared channel (PDSCH). A PDCCH scheduling the PDSCH carrying the RAR is addressed to a RA-radio network temporary identifier (RA-RNTI). The RA-RNTI identifies the time-frequency resource (also referred to as a physical RA channel (PRACH) occasion or PRACH transmission (TX) occasion or RA channel (RACH) occasion) in which the RA preamble was detected by the gNB. The RA-RNTI is calculated as follows: RA-RNTI=1+s_id+14*t_id+14*80*f_id+14*80*8*ul_carrier_id, where s_id is the index of the first orthogonal frequency division multiplexing (OFDM) symbol of the PRACH occasion where the UE has transmitted Msg1, i.e., the RA preamble; 0≤s_id<14; t_id is the index of the first slot of the PRACH occasion (0≤t_id<80); f_id is the index of the PRACH occasion within the slot in the frequency domain (0≤f_id<8), and ul_carrier_id is the UL carrier used for the Msg1 transmission (0 for normal UL (NUL) carrier and 1 for supplementary UL (SUL) carrier. Several RARs for various random-access preambles detected by the gNB can be multiplexed in the same RAR media access control (MAC) protocol data unit (PDU) by the gNB. A RAR in the MAC PDU corresponds to the UE's RA preamble transmission if the RAR includes an RA preamble identifier (RAPID) of RA preamble transmitted by the UE. If the RAR corresponding to the UE's RA preamble transmission is not received during the RAR window and the UE has not yet transmitted the RA preamble for a configurable (configured by the gNB in a RACH configuration) number of times, the UE goes back to the first step i.e., the UE selects a random access resource (preamble/RACH occasion) and transmits the RA preamble. A backoff may be applied before going back to first step.

If the RAR corresponding to the UE's RA preamble transmission is received the UE transmits a message 3 (Msg3) in the UL grant received in the RAR. The Msg3 includes a message such as an RRC connection request, RRC connection re-establishment request, RRC handover confirm, scheduling request, SI request etc. The Msg3 may include the UE identity (i.e., a cell-radio network temporary identifier (C-RNTI) or system architecture evolution (SAE)-temporary mobile subscriber identity (S-TMSI) or a random number). After transmitting the Msg3, the UE starts a contention resolution timer. While the contention resolution timer is running, if the UE receives a physical downlink control channel (PDCCH) addressed to the C-RNTI included in the Msg3, contention resolution is considered successful, the contention resolution timer is stopped, and the RA procedure is completed. While the contention resolution timer is running, if the UE receives a contention resolution MAC control element (CE) including the UE's contention resolution identity (first X bits of common control channel (CCCH) service data unit (SDU) transmitted in Msg3), contention resolution is considered successful, the contention resolution timer is stopped, and the RA procedure is completed. If the contention resolution timer expires and the UE has not yet transmitted the RA preamble for a configurable number of times, the UE goes back to first step i.e., selecting a random access resource (preamble/RACH occasion) and transmits the RA preamble. A backoff may be applied before going back to first step.

Contention free random access (CFRA), also referred as legacy CFRA or 4 step CFRA, is used for scenarios such as handover where low latency is required, timing advance establishment for a secondary cell (SCell), etc. In CFRA, an evolved node B (eNB) assigns to the UE a dedicated random access preamble. The UE transmits the dedicated RA preamble. The eNB transmits the RAR on a PDSCH addressed to the RA-RNTI. The RAR conveys the RA preamble identifier and timing alignment information. The RAR may also include an UL grant. The RAR is transmitted in a RAR window similar to contention-based RA (CBRA) procedure. The CFRA is considered successfully completed after receiving the RAR including the RA preamble identifier (RAPID) of the RA preamble transmitted by the UE. In case the RA is initiated for beam failure recovery, the CFRA is considered successfully completed if a PDCCH addressed to the C-RNTI is received in the search space for beam failure recovery. If the RAR window expires and the RA is not successfully completed and the UE has not yet transmitted the RA preamble for a configurable (configured by the gNB in a RACH configuration) number of times, the UE retransmits the RA preamble.

For certain events such has handover and beam failure recovery if dedicated preamble(s) are assigned to the UE, during the first step of random access i.e., during random access resource selection for Msg1 transmission, the UE determines whether to transmit a dedicated preamble or non-dedicated preamble. Dedicated preambles are typically provided for a subset of SSBs/CSI RSs. If there is no SSB/CSI RS having DL RSRP above a threshold amongst the SSBs/CSI RSs for which contention free random access resources (i.e., dedicated preambles/ROs) are provided by gNB, the UE selects a non-dedicated preamble. Otherwise, the UE selects a dedicated preamble. So, during the RA procedure, one random access attempt can be a CFRA while another random access attempt can be a CBRA.

For 2 step contention based random access (2 step CBRA), in the first step, the UE transmits a random access preamble on a PRACH and a payload (i.e., MAC PDU) on a PUSCH. The random access preamble and payload transmission is also referred as a MsgA. In the second step, after the MsgA transmission, the UE monitors for a response from the network (i.e., gNB) within a configured window. The response is also referred as a MsgB. A next generation node B (gNB) transmits the MsgB on physical downlink shared channel (PDSCH). A PDCCH scheduling the PDSCH carrying the MsgB is addressed to a MsgB-radio network temporary identifier (MSGB-RNTI). The MSGB-RNTI identifies the time-frequency resource (also referred to as a physical RA channel (PRACH) occasion or PRACH transmission (TX) occasion or RA channel (RACH) occasion) in which the RA preamble was detected by the gNB. The MSGB-RNTI is calculated as follows: RA-RNTI=1+s_id+14*t_id+14*80*f_id+14*80*8*ul_carrier_id+14×80×8×2, where s_id is the index of the first orthogonal frequency division multiplexing (OFDM) symbol of the PRACH occasion where the UE has transmitted the Msg1, i.e., a RA preamble; 0≤s_id<14; t_id is the index of the first slot of the PRACH occasion (0≤t_id<80); f_id is the index of the PRACH occasion within the slot in the frequency domain (0≤f_id<8), and ul_carrier_id is the UL carrier used for Msg1 transmission (0 for normal UL (NUL) carrier and 1 for supplementary UL (SUL) carrier.

If a CCCH SDU was transmitted in the MsgA payload, the UE performs contention resolution using the contention resolution information in the MsgB. The contention resolution is successful if the contention resolution identity received in the MsgB matches the first 48 bits of the CCCH SDU transmitted in the MsgA. If the C-RNTI was transmitted in the MsgA payload, the contention resolution is successful if the UE receives a PDCCH addressed to the C-RNTI. If contention resolution is successful, the random access procedure is considered successfully completed. Instead of contention resolution information corresponding to the transmitted MsgA, the MsgB may include a fallback information corresponding to the random access preamble transmitted in the MsgA. If the fallback information is received, the UE transmits a Msg3 and performs contention resolution using Msg4 as in CBRA procedure. If contention resolution is successful, the random access procedure is considered successfully completed. If contention resolution fails upon fallback (i.e., upon transmitting Msg3), the UE retransmits the MsgA. If the configured window in which the UE monitors for a network response after transmitting the MsgA expires and the UE has not received MsgB including contention resolution information or fallback information as explained above, the UE retransmits MsgA. If the random access procedure is not successfully completed even after transmitting the msgA a configurable number of times, the UE falls back to the 4 step RACH procedure i.e., the UE only transmits the PRACH preamble.

A MsgA payload may include one or more of a common control channel (CCCH) service data unit (SDU), dedicated control channel (DCCH) SDU, dedicated traffic channel (DTCH) SDU, buffer status report (BSR) MAC control element (CE), power headroom report (PHR) MAC CE, SSB information, C-RNTI MAC CE, or padding. The MsgA may include a UE ID (e.g., random ID, S-TMSI, C-RNTI, resume ID, etc.) along with the preamble in the first step. The UE ID may be included in the MAC PDU of the MsgA. The UE ID such as a C-RNTI may be carried in the MAC CE wherein the MAC CE is included in the MAC PDU. Other UE IDs (such as a random ID, S-TMSI, C-RNTI, resume ID, etc.) may be carried in the CCCH SDU. The UE ID can be one of a random ID, S-TMSI, C-RNTI, resume ID, IMSI, idle mode ID, inactive mode ID, etc. The UE ID can be different in different scenarios in which the UE performs the RA procedure. When the UE performs RA after power on (before it is attached to the network), then the UE ID is the random ID. When the UE performs RA in an IDLE state after it is attached to the network, the UE ID is an S-TMSI. If the UE has an assigned C-RNTI (e.g., in a connected state), the UE ID is a C-RNTI. In case the UE is in an INACTIVE state, the UE ID is a resume ID. In addition to the UE ID, some additional control information can be sent in the MsgA. The control information may be included in the MAC PDU of the MsgA. The control information may include one or more of a connection request indication, connection resume request indication, SI request indication, buffer status indication, beam information (e.g., one or more DL TX beam ID(s) or SSB ID(s)), beam failure recovery indication/information, data indicator, cell/BS/TRP switching indication, connection re-establishment indication, reconfiguration complete or handover complete message, etc.

In 2 step contention free random access (2 step CFRA), the gNB assigns to the UE dedicated Random access preamble (s) and PUSCH resource(s) for a MsgA transmission. RO(s) to be used for preamble transmission may also be indicated. In the first step, the UE transmits a random access preamble on a PRACH and a payload on a PUSCH using the contention free random access resources (i.e., dedicated preamble/PUSCH resource/RO). In the second step, after the MsgA transmission, the UE monitors for a response from the network (i.e., the gNB) within a configured window. The response is also referred as a MsgB.

The next generation node B (gNB) transmits the MsgB on a physical downlink shared channel (PDSCH). A PDCCH scheduling the PDSCH carrying the MsgB is addressed to a MsgB-radio network temporary identifier (MSGB-RNTI). The MSGB-RNTI identifies the time-frequency resource (also referred to as a physical RA channel (PRACH) occasion or PRACH transmission (TX) occasion or RA channel (RACH) occasion) in which the RA preamble was detected by the gNB. The MSGB-RNTI is calculated as follows: RA-RNTI=1+s_id+14*t_id+14*80*f_id+14*80*8*ul_carrier_id+14×80×8×2, where s_id is the index of the first orthogonal frequency division multiplexing (OFDM) symbol of the PRACH occasion where the UE has transmitted the Msg1, i.e., the RA preamble; 0≤s_id<14; t_id is the index of the first slot of the PRACH occasion (0≤t_id<80); f_id is the index of the PRACH occasion within the slot in the frequency domain (0≤f_id<8), and ul_carrier_id is the UL carrier used for Msg1 transmission (0 for normal UL (NUL) carrier and 1 for supplementary UL (SUL) carrier.

If the UE receives a PDCCH addressed to the C-RNTI, the random access procedure is considered successfully completed. If the UE receives fallback information corresponding to its transmitted preamble, the random access procedure is considered successfully completed.

In the next generation wireless communication system (e.g., 5G, beyond 5G, 6G) the UE can be in one of the following RRC states: RRC IDLE, RRC INACTIVE and RRC CONNECTED. The RRC states can further be characterized as follows:

In the RRC_IDLE state, a UE specific DRX may be configured by upper layers (i.e., NAS). The UE monitors Short Messages transmitted with P-RNTI over DCI; monitors a paging channel for CN paging using a 5G-S-TMSI; performs neighbouring cell measurements and cell (re-)selection; and acquires system information and can send SI requests (if configured).

In the RRC_INACTIVE state, a UE specific DRX may be configured by upper layers or by the RRC layer. In this state, the UE stores the UE Inactive AS context. A RAN-based notification area is configured by the RRC layer. The UE monitors Short Messages transmitted with P-RNTI over DCI; monitors a paging channel for CN paging using a 5G-S-TMSI and RAN paging using a full I-RNTI; performs neighbouring cell measurements and cell (re-)selection; performs RAN-based notification area updates periodically and when moving outside the configured RAN-based notification area; and acquires system information and can send SI requests (if configured).

In the RRC_CONNECTED state, the UE stores the AS context. Unicast data is transmitted/received to/from the UE. At lower layers, the UE may be configured with a UE specific DRX. The UE monitors Short Messages transmitted with a P-RNTI over DCI, if configured; monitors control channels associated with the shared data channel to determine if data is scheduled for the UE; provides channel quality and feedback information; performs neighbouring cell measurements and measurement reporting; and acquires system information.

Paging allows the network to reach UEs in the RRC_IDLE and in the RRC_INACTIVE state through Paging messages, and to notify UEs in the RRC_IDLE, the RRC_INACTIVE and the RRC_CONNECTED state of system information changes and ETWS(Earthquake and Tsunami Warning System)/CMAS (Commercial Mobile Alert System) indications through Short Messages. Both Paging messages and ShortMessages are addressed with P-RNTI on PDCCH, but while the former is sent on a PCCH logical channel (a TB carrying the paging message is transmitted over a PDSCH [Physical downlink shared channel]), the latter is sent over the PDCCH directly.

The next generation wireless communication system (e.g., 5G, beyond 5G, 6G) supports vehicular communication services. Vehicular communication services, represented by V2X services, can include the following four different types: V2V, V2I, V2N and V2P. In the next generation wireless communication system, V2X communication is being enhanced to support enhanced V2X use cases, which are broadly arranged into four use case groups:
1) Vehicle Platooning enables vehicles to dynamically form a platoon travelling together. All the vehicles in the platoon obtain information from the leading vehicle to manage this platoon. This information allows the vehicles to drive closer than normal in a coordinated manner, going in the same direction and travelling together.
2) Extended Sensors enables the exchange of raw or processed data gathered through local sensors or live video images among vehicles, road site units, devices of pedestrian and V2X application servers. The vehicles can increase the perception of their environment beyond of what their own sensors can detect and have a broader and holistic view of the local situation. High data rate is one of the key characteristics.
3) Advanced Driving enables semi-automated or full-automated driving. Each vehicle and/or RSU shares its own perception data obtained from its local sensors with vehicles in proximity and that allows vehicles to synchronize and coordinate their trajectories or maneuvers. Each vehicle shares its driving intention with vehicles in proximity too.
4) Remote Driving enables a remote driver or a V2X application to operate a remote vehicle for those passengers who cannot drive by themselves, or remote vehicles located in dangerous environments. For a case where variation is limited and routes are predictable, such as public transportation, driving based on cloud computing can be used. High reliability and low latency are the main requirements.

V2X services can be provided by a PC5 interface and/or a Uu interface. Support of V2X services via a PC5 interface is provided by NR sidelink communication or V2X sidelink communication, which is a mode of communication whereby UEs can communicate with each other directly over the PC5 interface using NR technology or EUTRA technology respectively without traversing any network node. This communication mode is supported when the UE is served by a RAN and when the UE is outside of RAN coverage. Only the UEs authorized to be used for V2X services can perform NR or V2X sidelink communication. Sidelink transmission and reception over the PC5 interface is supported when the UE is inside NG-RAN coverage, irrespective of which RRC state the UE is in, and when the UE is outside NG-RAN coverage. Support of V2X services via the PC5 interface can be provided by NR Sidelink Communication and/or V2X Sidelink Communication. NR Sidelink Communication may be used to support other services than V2X services.

NR or V2X Sidelink Communication can support three types of transmission modes. The first is unicast transmission, characterized by: support of at least one PC5-RRC connection between peer UEs; transmission and reception of control information and user traffic between peer UEs in sidelink; support of sidelink HARQ feedback; support of RLC AM; and support of sidelink RLM for both peer UEs to detect RLF. The second is groupcast transmission, characterized by: transmission and reception of user traffic among UEs belonging to a group in sidelink; and support of sidelink HARQ feedback. The third is broadcast transmission, characterized by: transmission and reception of user traffic among UEs in sidelink.

A Sidelink or PC5 interface supports UE-to-UE direct communication using sidelink resource allocation modes, and physical-layer signals/channels. Two sidelink resource allocation modes are supported: mode 1 and mode 2. In mode 1, the sidelink resource allocation is provided by the network. In mode 2, the UE decides the SL transmission resources in the resource pool(s). Physical Sidelink Control Channel (PSCCH) indicates resource and other transmission parameters used by a UE for PSSCH. PSCCH transmission is associated with a DM-RS. Sidelink control information (1^{st} stage SCI) is transmitted on a PSCCH. Physical Sidelink Shared Channel (PSSCH) transmits the transport blocks (TBs) of data themselves, and control information for HARQ procedures and CSI feedback triggers, etc. control information is referred to as 2^{nd} stage SCI. At least 6 OFDM symbols within a slot are used for PSSCH transmission. PSSCH transmission is associated with a DM-RS and may be associated with a PT-RS. A Physical Sidelink Feedback Channel (PSFCH) carries HARQ feedback over the sidelink from a UE which is an intended recipient of a PSSCH transmission to the UE which performed the transmission. A PSFCH sequence is transmitted in one PRB repeated over two OFDM symbols near the end of the sidelink resource in a slot. Sidelink HARQ feedback uses the PSFCH and can be operated in one of two options. In one option, which can be configured for unicast and groupcast, the PSFCH transmits either a positive acknowledgment (ACK) or negative acknowledgement (NACK) using a resource dedicated to a single PSFCH transmitting UE. In another option, which can be configured for groupcast, PSFCH transmits NACK, or no PSFCH signal is transmitted, on a resource that can be shared by multiple PSFCH transmitting UEs.

For transmitting data over a PC5 interface, the transmitter UE first transmits first Stage SCI over a PSCCH resource. The first stage SCI includes information about the transport block such as: priority, frequency resource assignment, time resource assignment, resource reservation period, DMRS pattern, second stage SCI format, MCS, number of DMRS port, etc. The transmitter UE then transmits second stage SCI over the PSSCH. The second stage SCI includes information such as, HARQ process number, NDI, RV, Source ID, Destination ID, HARQ feedback enabled/disabled indicator, cast type, CSI request, Zone ID, range, etc. The Transmitter UE then transmits a TB carrying a SL MAC PDU over PSSCH.

To facilitate for a gNB to reduce downlink transmission/uplink reception activity, an RRC Connected UE can be configured with a periodic cell discontinuous transmission (DTX)/discontinuous reception (DRX) pattern (i.e., active and non-active periods). The pattern configuration for cell DRX/DTX is common for the UEs supporting this feature in the cell. The cell DTX and cell DRX can be configured and activated separately. When the cell DTX is configured and activated for the concerned cell, the UE does not monitor the PDCCH in selected cases or SPS occasions during cell DTX non-active duration. When the cell DRX is configured and activated for the concerned cell, the UE does not transmit on CG resources or transmit an SR during the cell DRX non-active duration. This feature is only applicable to UEs in the RRC_CONNECTED state and it does not impact Random Access procedure, SSB transmission, paging, and system information broadcasting. Cell DTX/DRX can be activated/deactivated by RRC signaling or L1 group common signaling.

Cell DTX/DRX is characterized by the following:
active duration: the duration that the UE waits for to receive PDCCHs or SPS occasions and transmit SR or CG. In this duration, the gNB transmission/reception of PDCCH, SPS, SR and CG, are not impacted for the purpose of network energy saving;
cycle: specifies the periodic repetition of the active-duration followed by a period of non-active duration;

Active duration and cycle parameters are common between cell DTX and cell DRX, when both are configured.

Once the gNB recognizes there is an emergency call or public safety related service (e.g., MPS or MCS), the network should ensure that there is no impact to that service (e.g., it may release or deactivate the cell DTX/DRX configuration). The network should also ensure that there is at least partial overlapping between a UE's connected mode DRX on-duration and cell DTX/DRX active duration, e.g., the UE's connected mode DRX periodicity is a multiple of the cell DTX/DRX periodicity.

In existing wireless systems, for a UE configured with a SpCell and an SCell, beam failure detection and recovery may be configured for the SCell. When a Cell DRX is configured and activated for the SpCell, a beam failure is detected for the SCell, and a BFR is triggered, because UL-SCH resources are not available or UL-SCH resources are available, but the MAC CE cannot be accommodated in the available UL-SCH resource, the UE triggers a SR for SCell beam failure recovery.

In existing wireless systems, a triggered SR cannot be transmitted during a Cell DRX non-active period of a SpCell. Because the UE does not transmit in SR occasions overlapping with the Cell DRX non-active periods, e.g., SR transmissions are dropped during the non-active period. As a result, BFR will be delayed and the SCell cannot be used until the end of the Cell DRX non-active period even though the SCell is not in a network energy saving (NES) mode (i.e., the Cell DTX/DRX is not configured or activated for the Scell). The present disclosure provides methods that overcome these issues.

If ra-ContentionResolutionTimer or msgB-ResponseWindow is running and an SCell is in a Cell DTX non-active period, the UE monitors the PDCCH on the SCell during the Cell DTX non-active period. This is unnecessary and leads to increased energy consumption. The present disclosure provides methods that overcome these issues.

In existing wireless systems, in the case of scheduling mode 1 i.e., scheduled resource allocation for sidelink communication, if sl-PUCCH-Config is configured by RRC, a UE signals a negative or positive acknowledgement in the PUCCH transmission occasion corresponding to the sidelink grant. The PUCCH transmission occasion corresponding to the sidelink grant may occur during the Cell DRX non-active period. In this situation, the behavior of the UE is undefined. The present disclosure provides methods that define the UE's behavior during the Cell DRX non-active period.

As discussed above herein, the present disclosure provides solutions for BFR during a DRX non-active period of a SpCell. In one embodiment, a UE in an RRC_CONNECTED state receives an RRC Reconfiguration message from a gNB. The RRC Reconfiguration message is transmitted to the UE by the gNB in a dedicated manner. Note that even though the message is sent in dedicated manner, at least some information included in the message can be identical for multiple UEs. The RRC Reconfiguration message include one or more Cell DTX/DRX configurations. The Cell DTX/DRX configurations can be for one or more cells (or serving cells). In some embodiments, the serving cell can be a SpCell. In some embodiments, the serving cell can be an SCell. The RRC Reconfiguration message includes a beam failure detection and recovery configuration for one or more serving cells. In some embodiments, the serving cell can be a SpCell. In some embodiments, the serving cell can be an SCell.

Upon receiving the RRC Reconfiguration message, Cell DRX is activated for one or more serving cells using RRC signaling or L1 signaling such as PDCCH or L2 signaling such as a MAC CE. The Cell DRX includes periodic repetition of the active-duration, wherein the active-duration is followed by a period of non-active duration every Cell DRX cycle. This periodic repetition is specified by the Cell DRX cycle parameter.

During the RRC_CONNECTED state, the MAC entity in the UE detects a beam failure and triggers a beam failure recovery for a serving cell or for a beam failure detection-reference signal (BFD-RS set) (or TRP) of a serving cell. In some embodiments, the serving cell can be a SpCell. In some embodiments, the serving cell can be an SCell. For the triggered beam failure recovery, the MAC entity in UE may trigger a scheduling request for a beam failure recovery of the serving cell or for a beam failure recovery of the BFD-RS set (or TRP) of the serving cell. In some embodiments, the scheduling request configuration and resources (PUCCH) are configured via RRC signaling for beam failure recovery of the serving cell. In some embodiments, the scheduling request configuration and resources (PUCCH) are configured via RRC signaling for the beam failure recovery of the BFD-RS set (or TRP) of the serving cell. PUCCH resources of a SpCell (or PUCCH resources of a SCell) are used for the scheduling request for beam failure recovery of the serving cell or for beam failure recovery of the BFD-RS set of serving cell (e.g., by transmitting uplink control information [UCI]).

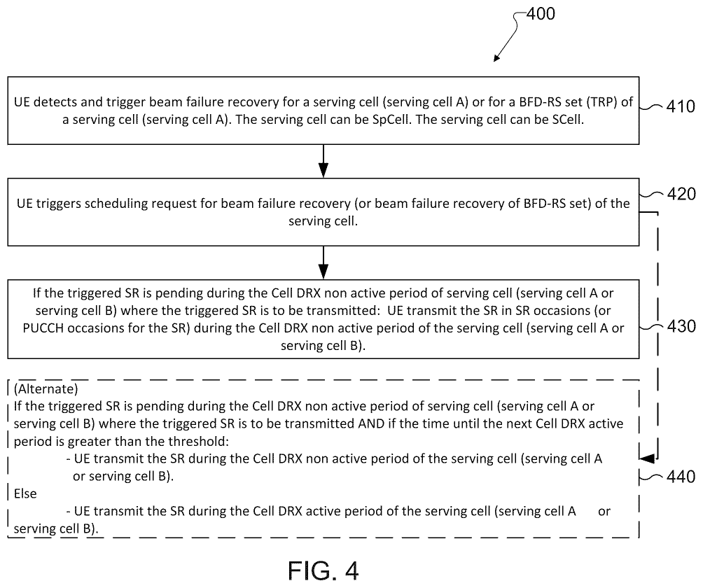

FIG. 4 illustrates an example UE operation for SR transmission during a Cell DRX non-active period 400 according to embodiments of the present disclosure. An embodiment of the operation illustrated in FIG. 4 is for illustration only. One or more of the components illustrated in FIG. 4 may be implemented in specialized circuitry configured to perform the noted functions or one or more of the components may be implemented by one or more processors executing instructions to perform the noted functions. Other embodiments for a UE operation for SR transmission during a Cell DRX non-active period could be used without departing from the scope of this disclosure.

In the example of FIG. 4, the operation begins at step 410. At step 410, a UE, such as UE 116 of FIG. 1, detects a beam failure and triggers beam failure recovery for a serving cell (serving cell A) or for a BFD-RS set (TRP) of a serving cell (serving cell A). The serving cell can be a SpCell or an SCell. At step 420, the UE triggers a scheduling request for the beam failure recovery (or beam failure recovery of the BFD-RS set) of the serving cell.

In one embodiment, if the SR triggered beam failure recovery of the serving cell (serving cell A) or for beam failure recovery of the BFD-RS set of the serving cell (serving cell A) is pending during the Cell DRX non-active period of the serving cell (serving cell A or serving cell B), where the SR is to be transmitted for beam failure recovery/beam failure recovery of the BFD-RS set of serving cell A, at step 430 the UE may transmit the SR in SR occasions (or PUCCH occasions for the SR) during the Cell DRX non-active period (or during the Cell DRX non-active period of the serving cell (serving cell A or serving cell B) where the SR is to be transmitted for beam failure recovery/beam failure recovery of the BFD-RS set of the serving cell A). Alternatively, at step 440, if the time until the next Cell DRX active period is greater than a threshold (the network may configure the threshold e.g., in a RRCReconfiguration message), the UE may transmit the SR in SR occasions (or PUCCH occasions for the SR) during the Cell DRX non-active period (or during the Cell DRX non-active period of the serving cell (serving cell A or serving cell B), where the SR is to be transmitted for beam failure recovery/beam failure recovery of the BFD-RS set of the serving cell A). Otherwise, the UE may transmit the SR in SR occasions (or PUCCH occasions for the SR) during the Cell DRX active period (or during the Cell DRX active period of the serving cell (serving cell A or serving cell B) where the SR is to be transmitted for beam failure recovery/beam failure recovery of the BFD-RS set of serving cell A).

In another embodiment, if the SR triggered beam failure recovery of the serving cell (SpCell) or for beam failure recovery of the BFD-RS set of the serving cell (SpCell) is pending during the Cell DRX non-active period of SpCell, at step 430, the UE may transmit the SR in SR occasions (or PUCCH occasions for the SR) during the Cell DRX non-active period (or during the Cell DRX non-active period of the SpCell). Alternatively, at step 440, if the time until the next Cell DRX active period is greater than a threshold (the network may configure the threshold e.g., in a RRCReconfiguration message), the UE may transmit the SR in SR occasions (or PUCCH occasions for the SR) during the Cell DRX non-active period (or during the Cell DRX non-active period of the SpCell). Otherwise, the UE may transmit the SR in SR occasions (or PUCCH occasions for the SR) during the Cell DRX active period (or during the Cell DRX active period of the SpCell).

In another embodiment, if the SR triggered beam failure recovery of the serving cell (SCell) or for beam failure recovery of the BFD-RS set of the serving cell (SCell) is pending during the Cell DRX non-active period of the SpCell, at step 430, the UE may transmit the SR in SR occasions (or PUCCH occasions for the SR) during the Cell DRX non-active period (or during the Cell DRX non-active period of the SpCell). Alternatively, at step 440, if the time until the next Cell DRX active period is greater than a threshold (the network may configure a threshold e.g., in an RRCReconfiguration message), the UE may transmit the SR in SR occasions (or PUCCH occasions for the SR) during the Cell DRX non-active period (or during the Cell DRX non-active period of the SpCell). Otherwise, the UE may transmit the SR in SR occasions (or PUCCH occasions for the SR) during the Cell DRX active period (or during the Cell DRX active period of the SpCell).

In another embodiment, if the SR triggered beam failure recovery of the serving cell (SCell A) or for beam failure recovery of the BFD-RS set of the serving cell (SCell A) is pending during the Cell DRX non-active period of the PUCCH SCell (the PUCCH SCell can be SCell A or the PUCCH SCell can be another SCell i.e., SCell B), at step 430, the UE may transmit the SR in SR occasions (or PUCCH occasions for the SR) during the Cell DRX non-active period (or during the Cell DRX non-active period of the PUCCH SCell). Alternatively, at step 440, if the time until the next Cell DRX active period is greater than a threshold (the network may configure the threshold e.g., in a RRCReconfiguration message), the UE may transmit the SR in SR occasions (or PUCCH occasions for the SR) during the Cell DRX non-active period (or during the Cell DRX non-active period of the PUCCH SCell). Otherwise, the UE may transmit the SR in SR occasions (or PUCCH occasions for the SR) during the Cell DRX active period (or during the Cell DRX active period of the PUCCH SCell).

Although FIG. 4 illustrates one example UE operation for SR transmission during a Cell DRX non-active period 400, various changes may be made to FIG. 4. For example, while shown as a series of steps, various steps in FIG. 4 could overlap, occur in parallel, occur in a different order, occur any number of times, be omitted, or replaced by other steps.

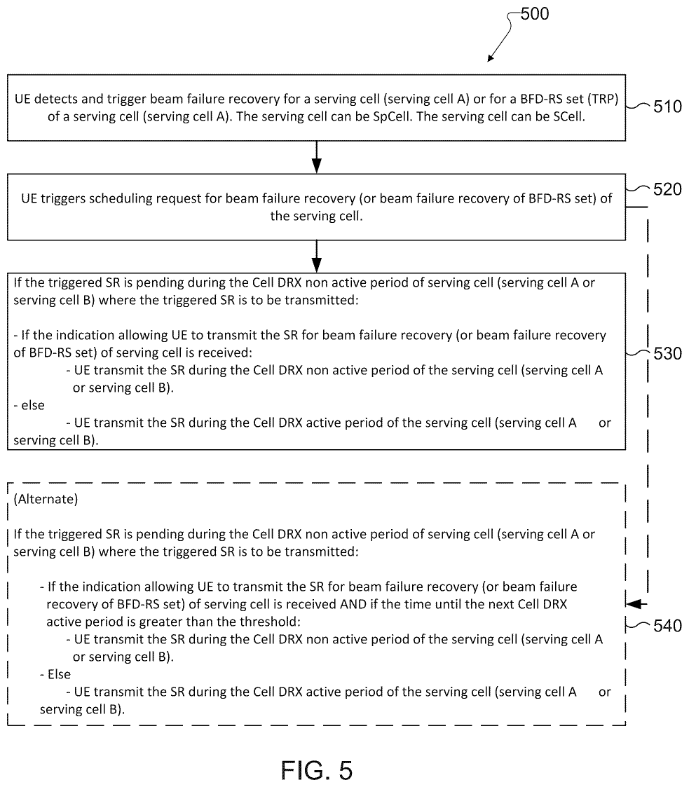

FIG. 5 illustrates another example UE operation for SR transmission during a Cell DRX non-active period 500 according to embodiments of the present disclosure. An embodiment of the operation illustrated in FIG. 5 is for illustration only. One or more of the components illustrated in FIG. 5 may be implemented in specialized circuitry configured to perform the noted functions or one or more of the components may be implemented by one or more processors executing instructions to perform the noted functions. Other embodiments for a UE operation for SR transmission during a Cell DRX non-active period could be used without departing from the scope of this disclosure.

In the example of FIG. 5, the operation begins at step 510. At step 510, a UE, such as UE 116 of FIG. 1, detects a beam failure and triggers beam failure recovery for a serving cell (serving cell A) or for a BFD-RS set (TRP) of a serving cell (serving cell A). The serving cell can be a SpCell or an SCell. At step 520, the UE triggers a scheduling request for the beam failure recovery (or beam failure recovery of the BFD-RS set) of the serving cell.

In one embodiment, the network (i.e., a gNB or base station) may indicate (e.g., in an RRCReconfiguration message) whether the UE is allowed to transmit the SR for beam failure recovery or the UE is allowed to transmit the SR for beam failure recovery of the BFD-RS set of the serving cell, during the Cell DRX non-active period. If the SR triggered beam failure recovery of the serving cell (serving cell A) or for beam failure recovery of the BFD-RS set of the serving cell (serving cell A) is pending during the Cell DRX non-active period of (serving cell A or serving cell B) where the SR is to be transmitted for beam failure recovery/beam failure recovery of the BFD-RS set of the serving cell A, at step 530, if the indication allowing the UE to transmit the SR for beam failure recovery or to transmit the SR for beam failure recovery of the BFD-RS set of the serving cell is received (or the indication is received for the SR/SR configuration associated with the triggered SR), the UE may transmit the SR in SR occasions (or PUCCH occasions for the SR) during the Cell DRX non-active period (or during the Cell DRX non-active period of SpCell). Alternatively, at step 540, if the indication allowing the UE to transmit the SR for beam failure recovery or to transmit the SR for beam failure recovery of the BFD-RS set of the serving cell is received (or the indication is received for the SR/SR configuration associated with the triggered SR) and if the time until the next Cell DRX active period is greater than a threshold (the network may configure the threshold e.g., in a RRCReconfiguration message), the UE may transmit the SR in SR occasions (or PUCCH occasions for the SR) during the Cell DRX non-active period (or during the Cell DRX non-active period of SpCell). Otherwise, the UE may transmit the SR in SR occasions (or PUCCH occasions for the SR) during the Cell DRX active period (or during the Cell DRX active period of the SpCell).

In another embodiment, the network (i.e., a gNB or base station) may indicate (e.g., in an RRCReconfiguration message) whether the UE is allowed to transmit the SR for beam failure recovery or the UE is allowed to transmit the SR for beam failure recovery of the BFD-RS set of the serving cell, during the Cell DRX non-active period. If the SR triggered beam failure recovery of serving cell (SpCell) or for beam failure recovery of BFD-RS set of the serving cell (SpCell) is pending during the Cell DRX non-active period of the SpCell, at step 530, if the indication allowing the UE to transmit the SR for beam failure recovery or to transmit the SR for beam failure recovery of the BFD-RS set of the serving cell is received (or the indication is received for the SR/SR configuration associated with the triggered SR), the UE may transmit the SR in SR occasions (or PUCCH occasions for the SR) during the Cell DRX non-active period (or during the Cell DRX non-active period of SpCell). Alternatively, at step 540, if the indication allowing the UE to transmit the SR for beam failure recovery or to transmit the SR for beam failure recovery of the BFD-RS set of the serving cell is received (or the indication is received for the SR/SR configuration associated with the triggered SR) and if the time until the next Cell DRX active period is greater than a threshold (the network may configure the threshold e.g., in an RRCReconfiguration message), the UE may transmit the SR in SR occasions (or PUCCH occasions for the SR) during the Cell DRX non-active period (or during the Cell DRX non-active period of SpCell). Otherwise, the UE may transmit the SR in SR occasions (or PUCCH occasions for the SR) during the Cell DRX active period (or during the Cell DRX active period of SpCell).

In another embodiment, the network (i.e., a gNB or base station) may indicate (e.g., in an RRCReconfiguration message) whether the UE is allowed to transmit the SR for beam failure recovery or the UE is allowed to transmit the SR for beam failure recovery of the BFD-RS set of the serving cell, during the Cell DRX non-active period. If the SR triggered beam failure recovery of the serving cell (SCell) or for beam failure recovery of the BFD-RS set of the serving cell (SCell) is pending during the Cell DRX non-active period of SpCell, at step 530, if the indication allowing the UE to transmit the SR for beam failure recovery or to transmit the SR for beam failure recovery of the BFD-RS set of the serving cell is received (or the indication is received for the SR/SR configuration associated with the triggered SR), the UE may transmit the SR in SR occasions (or PUCCH occasions for the SR) during the Cell DRX non-active period (or during the Cell DRX non-active period of SpCell). Alternately, at step 540, if the indication allowing the UE to transmit the SR for beam failure recovery or to transmit the SR for beam failure recovery of the BFD-RS set of the serving cell is received (or the indication is received for the SR/SR configuration associated with the triggered SR) and if the time until the next Cell DRX active period is greater than a threshold (the network may configure the threshold e.g., in a RRCReconfiguration message), the UE may transmit the SR in SR occasions (or PUCCH occasions for the SR) during the Cell DRX non-active period (or during the Cell DRX non-active period of the SpCell). Otherwise, the UE may transmit the SR in SR occasions (or PUCCH occasions for the SR) during the Cell DRX active period (or during the Cell DRX active period of SpCell).

In an alternate embodiment, the network (i.e., gNB or base station) may indicate (e.g., in an RRCReconfiguration message) whether the UE is allowed to transmit the SR for beam failure recovery or the UE is allowed to transmit the SR for beam failure recovery of the BFD-RS set of the serving cell, during the Cell DRX non-active period. If the SR triggered beam failure recovery of serving cell (SCell A) or for beam failure recovery of the BFD-RS set of the serving cell (SCell A) is pending during the Cell DRX non-active period of PUCCH SCell (PUCCH SCell can be SCell A or PUCCH SCell can be another SCell i.e., SCell B), at step 530, if the indication allowing the UE to transmit the SR for beam failure recovery or to transmit the SR for beam failure recovery of the BFD-RS set of the serving cell is received (or the indication is received for the SR/SR configuration associated with the triggered SR), the UE may transmit the SR in SR occasions (or PUCCH occasions for the SR) during the Cell DRX non-active period (or during the Cell DRX non-active period of the PUCCH SCell). Alternately, at step 540, if the indication allowing the UE to transmit the SR for beam failure recovery or to transmit the SR for beam failure recovery of the BFD-RS set of the serving cell is received (or the indication is received for the SR/SR configuration associated with the triggered SR) and if the time until the next Cell DRX active period is greater than a threshold (the network may configure the threshold e.g., in an RRCReconfiguration message), the UE may transmit the SR in SR occasions (or PUCCH occasions for the SR) during the Cell DRX non-active period (or during the Cell DRX non-active period of the PUCCH SCell). Otherwise, the UE may transmit the SR in SR occasions (or PUCCH occasions for the SR) during the Cell DRX active period (or during the Cell DRX active period of the PUCCH SCell).

Although FIG. 5 illustrates one example UE operation for SR transmission during a Cell DRX non-active period 500, various changes may be made to FIG. 5. For example, while shown as a series of steps, various steps in FIG. 5 could overlap, occur in parallel, occur in a different order, occur any number of times, be omitted, or replaced by other steps.

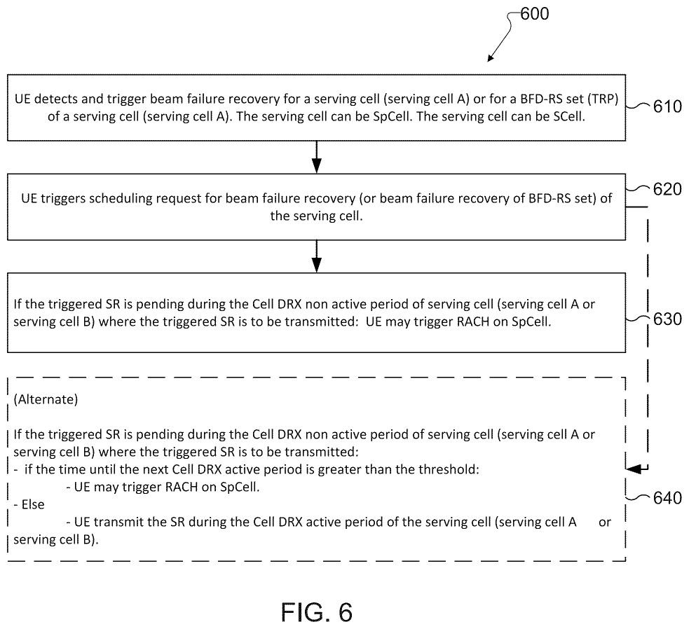

FIG. 6 illustrates an example UE operation for random access during a Cell DRX non-active period 600 according to embodiments of the present disclosure. An embodiment of the operation illustrated in FIG. 6 is for illustration only. One or more of the components illustrated in FIG. 6 may be implemented in specialized circuitry configured to perform the noted functions or one or more of the components may be implemented by one or more processors executing instructions to perform the noted functions. Other embodiments for a UE operation for random access during a Cell DRX non-active period could be used without departing from the scope of this disclosure.

In the example of FIG. 6, the operation begins at step 610. At step 610, a UE, such as UE 116 of FIG. 1, detects a beam failure and triggers beam failure recovery for a serving cell (serving cell A) or for a BFD-RS set (TRP) of a serving cell (serving cell A). The serving cell can be a SpCell or an SCell. At step 620, the UE triggers a scheduling request for the beam failure recovery (or beam failure recovery of the BFD-RS set) of the serving cell.

In one embodiment, if the SR triggered beam failure recovery of serving cell (serving Cell A) or for beam failure recovery of the BFD-RS set of the serving cell (Serving Cell A) is pending during the Cell DRX non-active period of serving cell (serving cell A or serving cell B) where the SR is to be transmitted for beam failure recovery/beam failure recovery of the BFD-RS set of the serving cell A, at step 630, the UE may trigger a RACH on the SpCell or the UE may trigger a RACH on the SpCell during the Cell DRX non-active period. Alternately, at step 640, if the time until the next Cell DRX active period is greater than a threshold (the network may configure the threshold e.g., in an RRCReconfiguration message), the UE may trigger a RACH on the SpCell or the UE may trigger a RACH on the SpCell during the Cell DRX non-active period. Otherwise, the UE transmits the SR during the Cell DRX active period of the serving cell (serving cell A or serving cell B).

In another embodiment, if the SR triggered beam failure recovery of the serving cell (SpCell) or for beam failure recovery of the BFD-RS set of the serving cell (SpCell) is pending during the Cell DRX non-active period of SpCell, at step 630, the UE may trigger a RACH on the SpCell during the Cell DRX non-active period (or during the Cell DRX non-active period of the SpCell). Alternately, at step 640, if the time until the next Cell DRX active period is greater than a threshold (the network may configure the threshold e.g., in an RRCReconfiguration message), the UE may trigger a RACH on the SpCell during the Cell DRX non-active period (or during the Cell DRX non-active period of the SpCell).

In another embodiment, if the SR triggered beam failure recovery of the serving cell (SCell) or for beam failure recovery of the BFD-RS set of the serving cell (SCell) is pending during the Cell DRX non-active period of SpCell, at step 630, the UE may trigger a RACH on the SpCell during the Cell DRX non-active period (or during the Cell DRX non-active period of the SpCell). Alternately, at step 640, if the time until the next Cell DRX active period is greater than a threshold (the network may configure the threshold e.g., in an RRCReconfiguration message), the UE may trigger a RACH on the SpCell during the Cell DRX non-active period (or during the Cell DRX non-active period of SpCell).

In another embodiment, if the SR triggered beam failure recovery of the serving cell (SCell A) or for beam failure recovery of the BFD-RS set of the serving cell (SCell A) is pending during the Cell DRX non-active period of the PUCCH SCell (the PUCCH SCell can be SCell A or the PUCCH SCell can be another SCell i.e., SCell B), at step 630, the UE may trigger a RACH on the SpCell or the UE may trigger a RACH on the SpCell during the Cell DRX non-active period. Alternately, at step 640, if the time until the next Cell DRX active period is greater than a threshold (the network may configure the threshold e.g., in an RRCReconfiguration message), the UE may trigger a RACH on the SpCell or the UE may trigger a RACH on the SpCell during the Cell DRX non-active period.

In another embodiment, the network (i.e., a gNB or base station) may indicate (e.g., in an RRCReconfiguration message) whether the UE is allowed to trigger a RACH on the SpCell for beam failure recovery or the UE is allowed to trigger a RACH on the SpCell for beam failure recovery of the BFD-RS set of the serving cell, during the Cell DRX non-active period. If the SR triggered beam failure recovery of the serving cell (serving Cell A) or for beam failure recovery of the BFD-RS set of the serving cell (Serving Cell A) is pending during the Cell DRX non-active period of serving cell (serving cell A or serving cell B) where the SR is to be transmitted for beam failure recovery/beam failure recovery of the BFD-RS set of the serving cell A, at step 630, if the indication allowing the UE to trigger a RACH on the SpCell for beam failure recovery or allowing the UE to trigger a RACH on the SpCell for beam failure recovery of the BFD-RS set of the serving cell is received (or the indication is received for the SR/SR configuration associated with the triggered SR), the UE may trigger a RACH on the SpCell or the UE may trigger a RACH on the SpCell during the Cell DRX non-active period. Alternately, if the indication allowing the UE to trigger a RACH on the SpCell for beam failure recovery or allowing the UE to trigger RACH on the SpCell for beam failure recovery of the BFD-RS set of the serving cell is received (or the indication is received for the SR/SR configuration associated with the triggered SR) and if the time until the next Cell DRX active period is greater than a threshold (the network may configure the threshold e.g., in an RRCReconfiguration message), the UE may trigger a RACH on the SpCell or the UE may trigger a RACH on the SpCell during the Cell DRX non-active period.

In another embodiment, the network (i.e., a gNB or base station) may indicate (e.g., in an RRCReconfiguration message) whether the UE is allowed to trigger a RACH on the SpCell for beam failure recovery or the UE is allowed to trigger a RACH on the SpCell for beam failure recovery of the BFD-RS set of the serving cell, during the Cell DRX non-active period. If the SR triggered beam failure recovery of the serving cell (SpCell) or for beam failure recovery of the BFD-RS set of the serving cell (SpCell) is pending during the Cell DRX non-active period of SpCell, at step 630, if the indication allowing the UE to trigger a RACH on the SpCell for beam failure recovery or allowing the UE to trigger a RACH on the SpCell for beam failure recovery of the BFD-RS set of the serving cell is received (or the indication is received for the SR/SR configuration associated with the triggered SR), the UE may trigger a RACH on the SpCell or the UE may trigger a RACH on the SpCell during the Cell DRX non-active period (or during the Cell DRX non-active period of SpCell). Alternately, at step 640, if the indication allowing the UE to trigger the RACH on the SpCell for beam failure recovery or allowing the UE to trigger a RACH on the SpCell for beam failure recovery of the BFD-RS set of the serving cell is received (or the indication is received for the SR/SR configuration associated with the triggered SR) and if the time until the next Cell DRX active period is greater than a threshold (the network may configure the threshold e.g., in an RRCReconfiguration message), the UE may trigger a RACH on the SpCell or UE may trigger a RACH on the SpCell during the Cell DRX non-active period (or during the Cell DRX non-active period of SpCell).

In another embodiment, the network (i.e., a gNB or base station) may indicate (e.g., in an RRCReconfiguration message) whether the UE is allowed to trigger a RACH on the SpCell for beam failure recovery or the UE is allowed to trigger a RACH on the SpCell for beam failure recovery of the BFD-RS set of the serving cell, during the Cell DRX non-active period. If the SR triggered beam failure recovery of the serving cell (SCell) or for beam failure recovery of the BFD-RS set of the serving cell (SCell) is pending during the Cell DRX non-active period of SpCell, at step 630, if the indication allowing the UE to trigger a RACH on the SpCell for beam failure recovery or allowing the UE to trigger RACH on the SpCell for beam failure recovery of the BFD-RS set of the serving cell is received (or the indication is received for the SR/SR configuration associated with the triggered SR), the UE may trigger a RACH on the SpCell during the Cell DRX non-active period (or during the Cell DRX non-active period of the SpCell). Alternately, at step 640, if the indication allowing the UE to trigger a RACH on the SpCell for beam failure recovery or allowing the UE to trigger a RACH on the SpCell for beam failure recovery of the BFD-RS set of the serving cell is received (or the indication is received for the SR/SR configuration associated with the triggered SR) and if the time until the next Cell DRX active period is greater than a threshold (the network may configure the threshold e.g., in an RRCReconfiguration message), the UE may trigger a RACH on the SpCell or the UE may trigger a RACH on the SpCell during the Cell DRX non-active period (or during the Cell DRX non-active period of the SpCell).

In an alternate embodiment, the network (i.e., a gNB or base station) may indicate (e.g., in an RRCReconfiguration message) whether the UE is allowed to trigger a RACH on the SpCell for beam failure recovery or the UE is allowed to trigger a RACH on the SpCell for beam failure recovery of the BFD-RS set of the serving cell, during the Cell DRX non-active period. If the SR triggered beam failure recovery of serving cell (SCell A) or for beam failure recovery of the BFD-RS set of the serving cell (SCell A) is pending during the Cell DRX non-active period of PUCCH SCell (PUCCH SCell can be SCell A or PUCCH SCell can be another SCell i.e., SCell B), at step 630, if the indication allowing the UE to trigger a RACH on the SpCell for beam failure recovery or allowing the UE to trigger a RACH on the SpCell for beam failure recovery of the BFD-RS set of the serving cell is received (or the indication is received for the SR/SR configuration associated with the triggered SR), the UE may trigger a RACH on the SpCell or the UE may trigger a RACH on the SpCell during the Cell DRX non-active period. Alternately, at step 640, if the indication allowing the UE to trigger a RACH on the SpCell for beam failure recovery or allowing the UE to trigger a RACH on the SpCell for beam failure recovery of the BFD-RS set of the serving cell is received (or the indication is received for the SR/SR configuration associated with the triggered SR) and if the time until the next Cell DRX active period is greater than a threshold (the network may configure the threshold e.g., in an RRCReconfiguration message), the UE may trigger RACH on the SpCell or the UE may trigger a RACH on the SpCell during the Cell DRX non-active period.

Although FIG. 6 illustrates one example UE operation for random access during a Cell DRX non-active period 600, various changes may be made to FIG. 6. For example, while shown as a series of steps, various steps in FIG. 6 could overlap, occur in parallel, occur in a different order, occur any number of times, be omitted, or replaced by other steps.

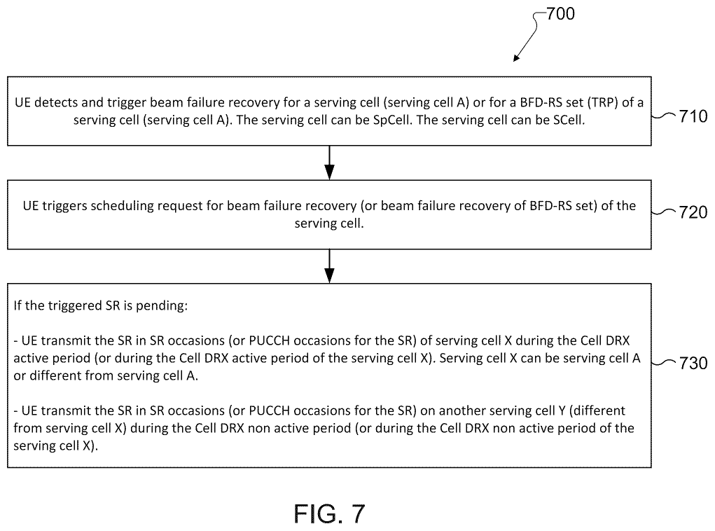

FIG. 7 illustrates an example UE operation for PUCCH Cell change during a Cell DRX non-active period 700 according to embodiments of the present disclosure. An embodiment of the operation illustrated in FIG. 7 is for illustration only. One or more of the components illustrated in FIG. 7 may be implemented in specialized circuitry configured to perform the noted functions or one or more of the components may be implemented by one or more processors executing instructions to perform the noted functions. Other embodiments for a UE operation for PUCCH Cell change access during a Cell DRX non-active period could be used without departing from the scope of this disclosure.

In the example of FIG. 7, the operation begins at step 710. At step 710, a UE, such as UE 116 of FIG. 1, detects a beam failure and triggers beam failure recovery for a serving cell (serving cell A) or for a BFD-RS set (TRP) of a serving cell (serving cell A). The serving cell can be a SpCell or an SCell. At step 720, the UE triggers a scheduling request for the beam failure recovery (or beam failure recovery of the BFD-RS set) of the serving cell.

In one embodiment, at step 730, if the SR triggered beam failure recovery of serving cell (serving cell A) or for beam failure recovery of the BFD-RS set of the serving cell (serving cell A) is pending, the UE transmits the SR in SR occasions (or PUCCH occasions for the SR) of a serving cell X during the Cell DRX active period (or during the Cell DRX active period of the serving cell X). Serving cell X can be serving cell A or different from serving cell A. The UE transmits the SR in SR occasions (or PUCCH occasions for the SR) on another serving cell Y (different from serving cell X) during the Cell DRX non-active period (or during the Cell DRX non-active period of the serving cell X). Another serving cell (different from serving cell A) where the UE can transmit the SR during the Cell DRX non-active period of the serving cell X can be signaled/configured/indicated by the gNB e.g., in an RRCReconfiguration message. The SR configuration for this another cell can be the same as serving cell X or it can be signaled/configured/indicated by the gNB e.g., in an RRCReconfiguration message. In one embodiment, the UE transmits the SR in SR occasions (or PUCCH occasions for the SR) on another serving cell Y (different from serving cell X) during the Cell DRX non-active period (or during the Cell DRX non-active period of the serving cell X), if the time until the Cell DRX active period is greater than a configured threshold (the threshold can be configured by the gNB in an RRCReconfiguration message).

In another embodiment, at step 730, if the SR triggered beam failure recovery of the serving cell (SpCell) or for beam failure recovery of the BFD-RS set of the serving cell (SpCell) is pending, the UE transmits the SR in SR occasions (or PUCCH occasions for the SR) on another serving cell (different from the SpCell) during the Cell DRX non-active period (or during the Cell DRX non-active period of the SpCell). Another serving cell (different from the SpCell) where the UE can transmit the SR during the Cell DRX non-active period of the SpCell can be signaled/configured/indicated by the gNB e.g., in an RRCReconfiguration message. The SR configuration for this another cell can be the same as the SpCell or it can be signaled/configured/indicated by the gNB e.g., in an RRCReconfiguration message. In one embodiment, the UE transmits the SR in SR occasions (or PUCCH occasions for the SR) on another serving cell (different from the SpCell) during the Cell DRX non-active period (or during the Cell DRX non-active period of the SpCell), if the time until the Cell DRX active period is greater than a configured threshold (the threshold can be configured by the gNB in an RRCReconfiguration message). The UE transmits the SR in SR occasions (or PUCCH occasions for the SR) of the SpCell during the Cell DRX active period (or during the Cell DRX active period of the SpCell).

In another embodiment, at step 730, if the SR triggered beam failure recovery of the serving cell (SCell) or for beam failure recovery of the BFD-RS set of the serving cell (SCell) is pending, the UE transmits the SR in SR occasions (or PUCCH occasions for the SR) on another serving cell (different from the SpCell) during the Cell DRX non-active period (or during the Cell DRX non-active period of the SpCell). Another serving cell (different from the SpCell) where the UE can transmit the SR during the Cell DRX non-active period of the SpCell can be signaled/configured/indicated by gNB e.g., in an RRCReconfiguration message. The SR configuration for this another cell can be the same as the SpCell or it can be signaled/configured/indicated by the gNB e.g., in an RRCReconfiguration message. The UE transmits the SR in SR occasions (or PUCCH occasions for the SR) on another serving cell (different from the SpCell) during the Cell DRX non-active period (or during the Cell DRX non-active period of the SpCell), if the time until the Cell DRX active period is greater than a configured threshold (the threshold can be configured by the gNB in an RRCReconfiguration message). The UE transmits the SR in SR occasions (or PUCCH occasions for the SR) of the SpCell during the Cell DRX active period (or during the Cell DRX active period of the SpCell).

In another embodiment, at step 730, if the SR triggered beam failure recovery of the serving cell (SCell A) or for beam failure recovery of the BFD-RS set of the serving cell (SCell A) is pending during the Cell DRX non-active period of the PUCCH SCell (the PUCCH SCell can be SCell A or the PUCCH SCell can be another SCell i.e., SCell B), the UE transmits the SR in SR occasions (or PUCCH occasions for the SR) on another serving cell (different from the PUCCH SCell) during the Cell DRX non-active period (or during the Cell DRX non-active period of the SpCell). Another serving cell (different from the PUCCH SCell) where the UE can transmit The SR during the Cell DRX non-active period of the PUCCH SCell can be signaled/configured/indicated by the gNB e.g., in an RRCReconfiguration message. The SR configuration for this another cell can be the same as the PUCCH SCell or it can be signaled/configured/indicated by the gNB e.g., in an RRCReconfiguration message. In one embodiment, the UE transmits the SR in SR occasions (or PUCCH occasions for the SR) on another serving cell (different from PUCCH SCell) during the Cell DRX non-active period (or during the Cell DRX non-active period of the SpCell), if the time until the Cell DRX active period is greater than a configured threshold (the threshold can be configured by gNB in RRCReconfiguration message). The UE transmits the SR in SR occasions (or PUCCH occasions for the SR) on the PUCCH SCell during the Cell DRX active period (or during the Cell DRX active period of the PUCCH SCell).

In one embodiment, the above methods/embodiments can also be applied for SR triggered for consistent LBT failure recovery for the SCell.

In one embodiment, the UE can be configured with a plurality of serving cells in a cell group (MCG or SCG). For all serving cells for which a serving Cell X is used for PUCCH transmission (e.g., PUCCH for HARQ feedback, PUCCH for SR etc), another serving cell Y can be configured for PUCCH transmission. During serving cell X's Cell DRX active period PUCCH transmission or SR transmission is performed on serving cell X. During serving cell X's Cell DRX non-active period if serving cell Y for PUCCH transmission is configured (or if serving cell Y for PUCCH transmission is configured and serving cell Y is in a Cell DRX active period) PUCCH transmission or SR transmission (which were supposed to be transmitted on serving cell X, but cannot be transmitted due to Cell DRX non-active period of serving cell X) is performed on serving cell Y. Otherwise, PUCCH transmission or SR transmission is not performed (or may be performed on serving cell X based on a network indication).

Although FIG. 7 illustrates one example UE operation for PUCCH cell change during a Cell DRX non-active period 700, various changes may be made to FIG. 7. For example, while shown as a series of steps, various steps in FIG. 7 could overlap, occur in parallel, occur in a different order, occur any number of times, be omitted, or replaced by other steps.

As discussed above herein, the present disclosure provides methods that define UE behavior during a PUCCH transmission occasion corresponding to a sidelink grant occurring during a Cell DRX non-active period. In one embodiment, the UE is configured by the gNB with scheduling mode 1 (i.e., scheduled resource allocation for sidelink communication). The UE is also configured by the gNB with sl-PUCCH-Config. The configurations are received using an RRCReconfiguration message. A PUCCH transmission occasion (configured by sl-PUCCH-Config) corresponding to a sidelink grant for transmitting an acknowledgment (negative or positive) to the gNB occurs during a Cell DRX non-active period (or during a Cell DRX non-active period of the SpCell). The sidelink grant is used by the UE to transmit sidelink information (e.g., a sidelink MAC PDU) to another UE. If the sidelink information (e.g., a sidelink MAC PDU) to another UE is successfully transmitted (or is successfully received by the other UE), a PUCCH transmission occasion (configured by sl-PUCCH-Config) corresponding to the sidelink grant is used for transmitting a positive acknowledgment. If the sidelink information (e.g., a sidelink MAC PDU) to another UE is not successfully transmitted (or is not successfully received by the other UE), the PUCCH transmission occasion (configured by sl-PUCCH-Config) corresponding to the sidelink grant is used for transmitting a negative acknowledgment.

In one embodiment, the UE transmits the acknowledgement (negative or positive) in the PUCCH transmission occasion corresponding to the sidelink grant even if the PUCCH transmission occasion occurs during the Cell DRX non-active period (or during the Cell DRX non-active period of the SpCell).

In another embodiment, the UE does not transmit the negative or positive acknowledgement in the PUCCH transmission occasion corresponding to the sidelink grant if the PUCCH transmission occasion occurs during the Cell DRX non-active period (or during the Cell DRX non-active period of the SpCell).

In another embodiment, whether to allow transmission in the PUCCH transmission occasion corresponding to the sidelink grant if the PUCCH transmission occasion occurs during the Cell DRX non-active period can be configurable/indicated by the gNB in ab RRCReconfiguration message. If the gNB indicates that the UE is allowed to transmit a negative or positive acknowledgement in the PUCCH transmission occasion (corresponding to the sidelink grant) occurring during the Cell DRX non-active period (or during the Cell DRX non-active period of the SpCell), the UE transmits the acknowledgement (negative or positive) in the PUCCH transmission occasion corresponding to the sidelink grant even if the PUCCH transmission occasion occurs during the Cell DRX non-active period (or during the Cell DRX non-active period of the SpCell). Otherwise, the UE does not transmit a negative or positive acknowledgement in the PUCCH transmission occasion corresponding to the sidelink grant if the PUCCH transmission occasion occurs during the Cell DRX non-active period (or during the Cell DRX non-active period of the SpCell).

As previously described herein, a UE may initiate a random access with a cell during a Cell DTX or Cell DRX period. In one embodiment the UE is in an RRC_CONNECTED state. The UE receives an RRC Reconfiguration message from gNB. The RRC Reconfiguration message is transmitted to UE by the gNB in a dedicated manner. Note that even though the message is sent in a dedicated manner, some information included in the message can be the same for multiple UEs. The UE is configured with multiple serving cells in a cell group. The Cell group can be an MCG or SCG. One serving cell is a SpCell. Other serving cells are SCells.

The RRC Reconfiguration message includes one or more Cell DTX/DRX configurations. The Cell DTX/DRX configurations can be for one or more cells (or serving cells). The serving cell can be a SpCell. The serving cell can be an SCell.

Upon receiving the RRC Reconfiguration message, Cell DTX is activated for one or more serving cells using RRC signaling or L1 signaling such as PDCCH. The Cell DTX includes periodic repetition of the active-duration wherein the active-duration is followed by a period of non-active duration every cell DRX cycle. This periodic repetition is specified by the parameter Cell DTX cycle.

The UE may initiate a random access procedure.

In the case of a 2 step RA procedure, upon transmitting a MsgA (PRACH preamble and MsgA MAC PDU), the UE starts msgB-ResponseWindow to receive a MsgB. In one embodiment, while msgB-ResponseWindow is running, the UE monitors the PDCCH addressed to MsgB-RNTI on the SpCell, irrespective of the cell DTX active period/cell DTX Inactive Period/cell DTX configuration of the SpCell. If the cell DTX is configured/activated for a serving cell and the serving cell is a SpCell and msgB-Response Window is running, the UE monitors the PDCCH addressed to the MsgB-RNTI on the SpCell, irrespective of the cell DTX active period/cell DTX inactive period of the SpCell (i.e., if msgB-Response Window is running during the cell DTX active period, the UE monitors the PDCCH addressed to the MsgB-RNTI on the SpCell; if msgB-ResponseWindow is running during the cell DTX inactive period, the UE monitors the PDCCH addressed to the MsgB-RNTI on the SpCell).

In the case of a 4 step RA procedure, upon transmitting a Msg 1 (PRACH preamble), the UE starts rar-ResponseWindow to receive a Msg2 or RAR. In one embodiment, while rar-ResponseWindow is running, the UE monitors the PDCCH addressed to RA-RNTI on the SpCell, irrespective of the cell DTX active period/cell DTX Inactive Period/cell DTX configuration of the SpCell. If the Cell DTX is configured/activated for a serving cell and the serving cell is a SpCell and rar-ResponseWindow is running, the UE monitors the PDCCH addressed to the RA-RNTI on the SpCell, irrespective of the cell DTX active period/cell DTX inactive period of the SpCell (i.e. if rar-Response Window is running during cell DTX active period, the UE monitors the PDCCH addressed to the RA-RNTI on the SpCell; if rar-Response Window is running during the cell DTX inactive period, the UE monitors the PDCCH addressed to the RA-RNTI on the SpCell).

During the random access procedure, the UE may transmit a Msg3. Upon transmitting the Msg3, the UE starts ra-ContentionResolutionTimer to receive contention resolution message from the gNB. In one embodiment, while ra-ContentionResolutionTimer is running, the UE monitors the PDCCH addressed to C-RNTI (or TC-RNTI) on the SpCell, irrespective of the cell DTX active/Inactive Period/cell DTX configuration of SpCell. If the cell DTX is configured/activated for a serving cell and serving cell is a SpCell and ra-ContentionResolutionTimer is running, the UE monitors the PDCCH addressed to the C-RNTI (or TC-RNTI) on the SpCell, irrespective of the cell DTX active period/cell DTX inactive period of the SpCell (i.e. if ra-ContentionResolutionTimer is running during the cell DTX active period, the UE monitors the PDCCH addressed to the RA-RNTI on the SpCell; if ra-ContentionResolutionTimer is running during the cell DTX inactive period, the UE monitors the PDCCH addressed to the C-RNTI (or TC-RNTI) on the SpCell).

In another embodiment, while msgB-ResponseWindow ra-ContentionResolutionTimer rar-ResponseWindow is running, the UE monitors the PDCCH on the SpCell, irrespective of the cell DTX active/Inactive Period/cell DTX configuration of the SpCell.

In another embodiment, the cell DTX Active Period of the SpCell includes the time while msgB-ResponseWindow or ra-ContentionResolutionTimer or rar-ResponseWindow is running.

In another embodiment, while msgB-ResponseWindow ra-ContentionResolutionTimer rar-ResponseWindow is running during the DTX non-active period of the SCell, the UE should not monitor the PDCCH of the SCell during the DTX non-active period unless the retransmission timer is running.

In another embodiment, for a serving cell which is configured with CellDTX-Config and Cell DTX is activated, the cell DTX Active Period of the Serving Cell includes the time while:
msgB-ResponseWindow or ra-ContentionResolutionTimer or rar-ResponseWindow is running, if the Serving Cell is the SpCell.
celldtx-onDurationTimer is running for the associated Serving Cell

In another embodiment, for each Serving Cell configured with CellDTX-Config, the MAC entity shall, if the Serving Cell is not in the cell DTX Active Period:
not instruct the physical layer to receive transport block on the DL-SCH according to the configured downlink assignment;
not indicate the presence of any configured downlink assignment and deliver the stored HARQ information to the HARQ entity; and
if drx-RetransmissionTimerDL, drx-RetransmissionTimerUL or drx-RetransmissionTimerSL is not running on any Serving Cell in the DRX group, and if the serving cell is SpCell and if ra-ContentionResolutionTimer or msgB-ResponseWindow or rar-ResponseWindow is not running, and if a Scheduling Request is not sent on PUCCH and is not pending; and if a PDCCH indicating a new transmission addressed to the C-RNTI of the MAC entity has been received after successful reception of a Random Access Response for the Random Access Preamble not selected by the MAC entity among the contention-based Random Access Preamble, not monitor PDCCH for the MAC entity's C-RNTI, CI-RNTI, CS-RNTI, INT-RNTI, SFI-RNTI, SP-CSI-RNTI, TPC-PUCCH-RNTI, TPC-PUSCH-RNTI, TPC-SRS-RNTI, AI-RNTI, SL-RNTI, SLCS-RNTI and SL Semi-Persistent Scheduling V-RNTI.

In some circumstances, a UE may identify a TCI state for a non-zero common CORESET. In one embodiment, the UE receives an RRCReconfiguration message from the network (i.e., a gNB or base station). The received RRCReconfiguration message includes common configuration (ServingCellConfigCommon Field/IE) for a serving cell.

In one embodiment, the Common configuration (ServingCellConfigCommon) for the serving cell includes a common configuration (initialDownlinkBWP field/IE) of a non redcap specific initial downlink BWP. The non redcap specific initial downlink BWP configuration includes common PDCCH configuration. The common PDCCH configuration includes configuration of a Control Resource Set zero (i.e., a Control Resource Set with a zero CORESET ID) and/or non zero Control Resource Set (i.e., a Control Resource Set with a non zero CORESET ID).

In another embodiment, the Common configuration (ServingCellConfigCommon field/IE) for the serving cell includes a common configuration (initialDownlinkBWP-RedCap IE) of a redcap specific initial downlink BWP. The redcap specific initial downlink BWP configuration includes a common PDCCH configuration. The common PDCCH configuration includes a configuration of Control Resource Set zero (i.e., a Control Resource Set with a zero CORESET ID) and/or non zero Control Resource Set (i.e., Control Resource Set with a non zero CORESET ID).

The RRCReconfiguration message also includes dedicated a BWP configuration for one or more BWPs. The dedicated BWP configuration includes PDSCH configuration. The PDSCH configuration includes list of TCI states (tci-StatesToAddModList/tci-StatesToReleaseList or dl-OrJoint-TCI-State-ToAddModList and dl-OrJoint-TCI-State-ToReleaseList). tci-StatesToAddModList is a list of Transmission Configuration Indicator (TCI) states indicating a transmission configuration which includes QCL-relationships between the DL RSs in one RS set and the PDSCH DMRS ports. dl-OrJoint-TCI-State-ToAddModList is a list of Transmission Configuration Indicator (TCI) states indicating a transmission configuration which includes QCL-relationships between the DL RSs in one RS set and the PDSCH DMRS ports, PDCCH DMRS ports, and CSI-RS, and in the case of joint mode, also the PUSCH, PUCCH and SRS.

The UE receives the TCI State Indication for a UE-specific PDCCH MAC CE from the gNB. The MAC CE includes the parameters Serving Cell ID, CORESET ID and TCI State ID.

If the field of CORESET ID is set to 0, this field indicates a TCI-StateId for a TCI state of the first 64 TCI-states configured by tci-StatesToAddModList and tci-StatesToReleaseList in the PDSCH-Config in the active BWP or by dl-OrJoint-TCI-State-ToAddModList and dl-OrJoint-TCI-State-ToReleaseList in the PDSCH-Config in the active BWP.

If the CORESET ID in the MAC CE is set to the CORESET ID of the non zero CORESET configured by/included in the common PDCCH configuration of the initial BWP (initialDownlinkBWP-RedCap or initialDownlinkBWP) of the serving cell identified by Serving Cell ID:
In one embodiment, the TCI State ID field in the MAC CE indicates a TCI-StateId for a TCI state of the first 64 TCI-states configured by tci-StatesToAddModList and tci-StatesToReleaseList in the PDSCH-Config in the active BWP or by dl-OrJoint-TCI-State-ToAddModList and dl-OrJoint-TCI-State-ToReleaseList in the PDSCH-Config in the active BWP.
In an another embodiment, the TCI State ID field in the MAC CE indicates a TCI-StateId for a TCI state of the first 64 TCI-states configured by tci-StatesToAddModList and tci-StatesToReleaseList in the PDSCH-Config in the BWP indicated by initialDownlinkBWP-RedCap (redcap specific initial BWP) or by dl-OrJoint-TCI-State-ToAddModList and dl-OrJoint-TCI-State-ToReleaseList in the PDSCH-Config in the BWP indicated by initialDownlinkBWP-RedCap (redcap specific initial BWP), if the CORESET ID in the MAC CE is set to the CORESET ID of the non zero coreset configured by/included in the common PDCCH configuration of the initialDownlinkBWP-RedCap (redcap specific initial BWP).
In one embodiment, the TCI State ID field in the MAC CE indicates a TCI-StateId for a TCI state of the first 64 TCI-states configured by tci-StatesToAddModList and tci-StatesToReleaseList in the PDSCH-Config in the BWP indicated by initialDownlinkBWP (non redcap specific initial BWP) or by dl-OrJoint-TCI-State-ToAddModList and dl-OrJoint-TCI-State-ToReleaseList in the PDSCH-Config in the BWP indicated by initialDownlinkBWP (non redcap specific initial BWP), if the CORESET ID in the MAC CE is set to the CORESST ID of the non zero CORESET configured by/included in the common PDCCH configuration of the initialDownlinkBWP (non redcap specific initial BWP).

If the field of CORESET ID is set to a valueother than 0 and a non zero CORESET is configured by/included in the common PDCCH configuration of the initial BWP (initialDownlinkBWP-RedCap or initialDownlinkBWP), this field indicates a TCI-StateId configured by tci-StatesPDCCH-ToAddList if configured, and tci-StatesPDCCH-ToReleaseList if configured in the controlResourceSet identified by the indicated CORESET ID.

The UE receives a PDCCH based on the identified TCI state included in the MAC CE.

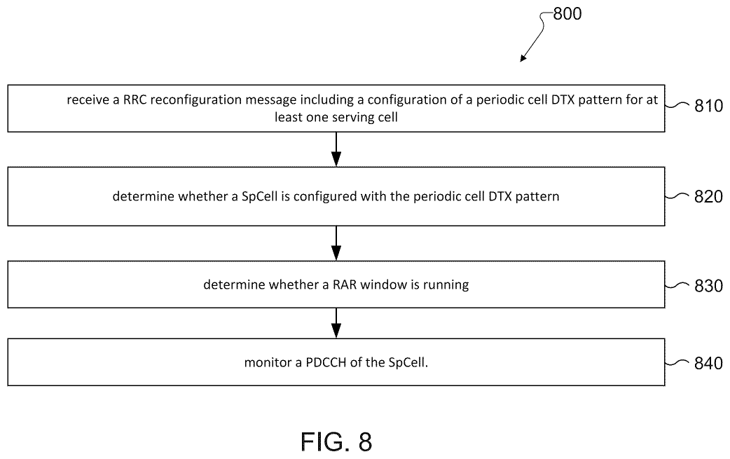

FIG. 8 illustrates an example method for energy saving in a wireless network 800 according to embodiments of the present disclosure. An embodiment of the operation illustrated in FIG. 8 is for illustration only. One or more of the components illustrated in FIG. 8 may be implemented in specialized circuitry configured to perform the noted functions or one or more of the components may be implemented by one or more processors executing instructions to perform the noted functions. Other embodiments for energy saving in a wireless network could be used without departing from the scope of this disclosure.

In the example of FIG. 8, the method begins at step 810. At step 810, a UE, such as UE 116 of FIG. 1, receives a RRC reconfiguration message including a configuration of a periodic cell DTX pattern for at least one serving cell.

At step 820, the UE determines whether a SpCell is configured with the periodic cell DTX pattern.

At step 830, the UE determines whether a RAR window is running.

At step 840, after a determination that the SpCell is configured with the periodic cell DTX pattern and the RAR window is running, the UE monitors a PDCCH of the SpCell.

Although FIG. 8 illustrates one example method for energy saving in a wireless network 800, various changes may be made to FIG. 8. For example, while shown as a series of steps, various steps in FIG. 8 could overlap, occur in parallel, occur in a different order, occur any number of times, be omitted, or replaced by other steps.

Any of the above variation embodiments can be utilized independently or in combination with at least one other variation embodiment. The above flowcharts illustrate example methods that can be implemented in accordance with the principles of the present disclosure and various changes could be made to the methods illustrated in the flowcharts herein. For example, while shown as a series of steps, various steps in each figure could overlap, occur in parallel, occur in a different order, or occur multiple times. In another example, steps may be omitted or replaced by other steps.

Although the present disclosure has been described with exemplary embodiments, various changes and modifications may be suggested to one skilled in the art. It is intended that the present disclosure encompass such changes and modifications as fall within the scope of the appended claims. None of the description in this application should be read as implying that any particular element, step, or function is an essential element that must be included in the claim scope. The scope of patented subject matter is defined by the claims.

What is claimed is:

1. A user equipment (UE) comprising:
a transceiver configured to:
receive a radio resource control (RRC) reconfiguration message including a configuration of a periodic cell discontinuous transmission (DTX) pattern for at least one serving cell; and
a processor operably coupled to the transceiver, the processor configured to:
determine whether a special cell (SpCell) is configured with the periodic cell DTX pattern;
determine whether a random access response (RAR) window is running; and
based on a determination that the SpCell is configured with the periodic cell DTX pattern and the RAR window is running, monitor a physical downlink control channel (PDCCH) of the SpCell.

2. The UE of claim 1, wherein:
the processor is further configured to determine whether the SpCell is in a cell DTX active period; and
to monitor the PDCCH, the processor is further configured to monitor the PDCCH during the cell DTX active period while the RAR window is running.

3. The UE of claim 1, wherein:
the processor is further configured to determine whether the SpCell is in a cell DTX non-active period; and
to monitor the PDCCH, the processor is further configured to monitor the PDCCH during the cell DTX non-active period while the RAR window is running.

4. The UE of claim 1, wherein:
the RRC reconfiguration message includes a configuration of a periodic cell discontinuous reception (DRX) pattern for the SpCell,
the transceiver is further configured to:
receive a grant for a sidelink (SL) resource for SL communication from the SpCell; and
transmit a SL media access control (MAC) protocol data unit (PDU) to another UE via the SL resource; and
the processor is further configured to:
determine whether a physical uplink control channel (PUCCH) transmission occasion corresponding with the SL resource occurs during a cell DRX active period of the SpCell or a cell DRX non-active period of the SpCell;
when the PUCCH transmission occasion corresponding with the SL resource occurs during the cell DRX active period of the SpCell, cause the transceiver to transmit one of a negative acknowledgement (NACK) or a positive acknowledgment (ACK) in the PUCCH transmission occasion; and
when the PUCCH transmission occasion corresponding with the SL resource occurs during the cell DRX non-active period of the SpCell, cause the transceiver to refrain from transmitting the one of the NACK or the ACK in the PUCCH transmission occasion.

5. The UE of claim 1, wherein:
the reconfiguration message includes a configuration of a periodic cell discontinuous reception (DRX) pattern for the SpCell; and
the transceiver is further configured to:
receive a grant for a sidelink (SL) resource for SL communication from the SpCell;
transmit a SL media access control (MAC) protocol data unit (PDU) to another UE via the SL resource; and
transmit one of a negative acknowledgement (NACK) or a positive acknowledgment (ACK) in a physical uplink control channel (PUCCH) transmission occasion corresponding with the SL resource.

6. The UE of claim 1, wherein:
the RRC reconfiguration message includes a configuration of a periodic cell discontinuous reception (DRX) pattern for a first serving cell;
the transceiver is further configured to:
receive a physical uplink control channel (PUCCH) configuration for the first serving cell; and
the processor is further configured to:
determine whether a PUCCH transmission occasion of the first serving cell occurs during a cell DRX active period of the first serving cell or cell DRX non-active period of the first serving cell;
when the PUCCH transmission occasion of the first serving cell occurs during the cell DRX active period of the first serving cell, cause the transceiver to transmit an uplink control information (UCI) in the PUCCH transmission occasion of the first serving cell; and
when the PUCCH transmission occasion of the first serving cell occurs during the cell DRX non-active period of the first serving cell, cause the transceiver to transmit the UCI in a PUCCH transmission occasion of a second serving cell.

7. The UE of claim 1, wherein:
the RRC reconfiguration message includes a configuration of a periodic cell discontinuous (DRX) pattern for a second serving cell;
the processor is further configured to determine whether a scheduling request (SR) triggered for a beam failure recovery of a first serving cell or for a beam failure recovery of a bidirectional forwarding detection-reference signal (BFD-RS) set of the first serving cell is pending during a cell DRX non-active period of the second serving cell, wherein the triggered SR is configured to be transmitted in the second serving cell; and
the transceiver is further configured to, based on the determination, transmit the SR in physical uplink control channel (PUCCH) occasions for the SR during the cell DRX non-active period of the second serving cell,
wherein the second serving cell can be a same cell or a different cell from the first serving cell.

8. A base station (BS) comprising:
a processor configured to:
determine whether at least one serving cell is configured with a periodic cell discontinuous transmission (DTX) pattern; and
a transceiver operably coupled to the processor, the transceiver configured to:
transmit a radio resource control (RRC) reconfiguration message including the configuration of the periodic cell DTX pattern for the at least one serving cell.

9. The BS of claim 8, wherein the at least one serving cell is a special cell (SpCell).

10. The BS of claim 9, wherein:
the processor is further configured to determine whether the SpCell is configured with a periodic cell discontinuous reception (DRX) pattern;
the RRC reconfiguration includes a configuration of the periodic cell DRX pattern for the SpCell; and
the transceiver is further configured to transmit a grant for a sidelink (SL) resource for SL communication from the SpCell.

11. The BS of claim 8, wherein:
the processor is further configured to determine whether the at least one serving cell is configured with a periodic cell discontinuous reception (DRX) pattern; and
the RRC reconfiguration includes the configuration of the periodic cell DRX pattern for the at least one serving cell.

12. The BS of claim 11, wherein:
the at least one serving cell is a first serving cell;
the transceiver is further configured to:
transmit a physical uplink control channel (PUCCH) configuration for the first serving cell;
receive, during a cell DRX active period of the first serving cell, an uplink control information (UCI) in a PUCCH transmission occasion of the first serving cell;
receive, during a cell DRX non-active period of the first serving cell the UCI in a PUCCH transmission occasion of a second serving cell.

13. The BS of claim 11 wherein:
the at least one serving cell is a second serving cell; and
the transceiver is further configured to receive a scheduling request (SR) triggered for a beam failure recovery of a first serving cell or for a beam failure recovery of a bidirectional forwarding detection-reference signal (BFD-RS) set of the first serving cell in a physical uplink control channel (PUCCH) occasions for the SR during a cell DRX non-active period of the second serving cell,
wherein the triggered SR is configured to be transmitted in the second serving cell, and
wherein the second serving cell can be a same cell or a different cell from the first serving cell.

14. A method of operating a user equipment (UE), the method comprising:
receiving a radio resource control (RRC) reconfiguration message including a configuration of a periodic cell discontinuous transmission (DTX) pattern for at least one serving cell;
determining whether a special cell (SpCell) is configured with the periodic cell DTX pattern;
determining whether a random access response (RAR) window is running; and
based on a determination that the SpCell is configured with the periodic cell DTX pattern and the RAR window is running, monitoring a physical downlink control channel (PDCCH) of the SpCell.

15. The method of claim 14, further comprising determining whether the SpCell is in a cell DTX active period,
wherein the PDCCH is monitored during the cell DTX active period while the RAR window is running.

16. The method of claim 14, further comprising determining whether the SpCell is in a cell DTX non-active period,
wherein the PDCCH is monitored during the cell DTX non-active period while the RAR window is running.

17. The method of claim 14, wherein:
the RRC reconfiguration message includes a configuration of a periodic cell discontinuous reception (DRX) pattern for SpCell; and
the method further comprises:
receiving a grant for a sidelink (SL) resource for SL communication from the SpCell;
transmitting a SL media access control (MAC) protocol data unit (PDU) to another UE via the SL resource;
determining whether a physical uplink control channel (PUCCH) transmission occasion corresponding with the SL resource occurs during a cell DRX active period of the SpCell or a cell DRX non-active period of the SpCell;
when the PUCCH transmission occasion corresponding with the SL resource occurs during the cell DRX active period of the SpCell, transmitting one of a negative acknowledgement (NACK) or a positive acknowledgment (ACK) in the PUCCH transmission occasion; and
when the PUCCH transmission occasion corresponding with the SL resource occurs during the cell DRX non-active period of the SpCell, refraining from transmitting the one of the NACK or the ACK in the PUCCH transmission occasion.

18. The method of claim 14, wherein:
the reconfiguration message includes a configuration of a periodic cell discontinuous reception (DRX) pattern for the SpCell; and
the method further comprises:
receiving a grant for a sidelink (SL) resource for SL communication from the SpCell;
transmitting a SL media access control (MAC) protocol data unit (PDU) to another UE via the SL resource; and
transmitting one of a negative acknowledgement (NACK) or a positive acknowledgment (ACK) in a physical uplink control channel (PUCCH) transmission occasion corresponding with the SL resource.

19. The UE of claim 14, wherein:
the RRC reconfiguration message includes a configuration of a periodic cell discontinuous reception (DRX) pattern for a first serving cell; and
the method further comprises:
receiving a physical uplink control channel (PUCCH) configuration for the first serving cell; and
determining whether a PUCCH transmission occasion of the first serving cell occurs during a cell DRX active period of the first serving cell or cell DRX non-active period of the first serving cell;
when the PUCCH transmission occasion of the first serving cell occurs during the cell DRX active period of the first serving cell, transmitting an uplink control information (UCI) in the PUCCH transmission occasion of the first serving cell; and
when the PUCCH transmission occasion of the first serving cell occurs during the cell DRX non-active period of the first serving cell, transmitting the UCI in a PUCCH transmission occasion of a second serving cell.

20. The method of claim 14, wherein:
the RRC reconfiguration message includes a configuration of a periodic cell discontinuous (DRX) pattern for a second serving cell; and
the method further comprises:
determining whether a scheduling request (SR) triggered for a beam failure recovery of a first serving cell or for a beam failure recovery of a bidirectional forwarding detection-reference signal (BFD-RS) set of the first serving cell is pending during a cell DRX non-active period of the second serving cell, wherein the triggered SR is configured to be transmitted in the second serving cell; and
transmitting the SR in physical uplink control channel (PUCCH) occasions for the SR during the cell DRX non-active period of the second serving cell,
wherein the second serving cell can be a same cell or a different cell from the first serving cell.
